(19) United States
(12) Patent Application Publication
(10) Pub. No.: US 2026/0323710 A1
(43) Pub. Date: Oct. 15, 2026

(54) Prach Repetition Transmission Method, Terminal, and Network Side Device

(71) Applicant: Vivo Mobile Communication Co., Ltd., Dongguan (CN)

(72) Inventors: Chengrui Wang, Dongguan (CN); Kun Yang, Dongguan (CN); Zhipeng Lin, Dongguan (CN); Yitao Mo, Dongguan (CN)

(21) Appl. No.: 19/461,367

(22) Filed: Jan. 27, 2026

Related U.S. Application Data
(63) Continuation of application No. PCT/CN2024/107005, filed on Jul. 23, 2024.

(30) Foreign Application Priority Data
Jul. 28, 2023 (CN) 202310947780.X

(51) Int. Cl. H04W 74/0833; H04B 7/06; H04B 17/318

(52) U.S. Cl. CPC H04W 74/0833; H04B 7/06952; H04B 17/328

(57) ABSTRACT

A PRACH repetition transmission method which pertains to the field of communication technologies, and includes repeatedly transmitting, by UE, PRACHs to a network side device by using at least two beams on a resource in a target resource set corresponding to a first number when RSRP of at least one downlink reference signal measured by the UE satisfies a target condition, where at least a part of beams of the at least two beams are different, the first number is a number of PRACH repetition transmission corresponding to the target condition, and the target condition is used to ensure that signal transmission quality of a beam or an antenna panel indicated by the network side device to the UE is greater than or equal to a signal transmission quality threshold.

### CROSS-REFERENCE TO RELATED APPLICATIONS

This application is a Bypass Continuation application of International Patent Application No. PCT/CN2024/107005 filed Jul. 23, 2024, and claims priority to Chinese Patent Application No. 202310947780.X, filed Jul. 28, 2023, the disclosures of which are hereby incorporated by reference in their entireties.

### BACKGROUND OF THE INVENTION

### Field of the Invention

This application pertains to the field of communication technologies, and specifically relates to a PRACH repetition transmission method, a terminal, and a network side device.

### Description of Related Art

In a random access process, user equipment (UE) may perform physical random access channel (PRACH) repetition transmission of different beams. Then, a network side device may indicate, based on the PRACH repetition transmission of the different beams, a beam or an antenna panel to the UE for transmitting a message (Msg) 3.

### SUMMARY OF THE INVENTION

Embodiments of this application provide a PRACH repetition transmission method, a terminal, and a network side device.

According to a first aspect, a PRACH repetition transmission method is provided and is performed by UE. The method includes: repeatedly transmitting, by the UE, PRACHs to a network side device by using at least two beams on a resource in a target resource set corresponding to a first number when reference signal received power (RSRP) of at least one downlink reference signal measured by the UE satisfies a target condition, where at least a part of beams of the at least two beams are different, the first number is a number of PRACH repetition transmission corresponding to the target condition, and the target condition is used to ensure that signal transmission quality of a beam or an antenna panel indicated by the network side device to the UE is greater than or equal to a signal transmission quality threshold.

According to a second aspect, a PRACH repetition transmission method is provided and is performed by a network side device. The method includes: receiving, by the network side device on a resource in a target resource set corresponding to a first number, PRACHs repeatedly transmitted by UE by using at least two beams, where at least a part of beams of the at least two beams are different, the first number is a number of PRACH repetition transmission corresponding to a target condition satisfied by RSRP of at least one downlink reference signal measured by the UE, and the target condition is used to ensure that signal transmission quality of a beam or an antenna panel indicated by the network side device to the UE is greater than or equal to a signal transmission quality threshold.

According to a third aspect, a PRACH repetition transmission apparatus is provided, and the apparatus includes a sending module. The sending module is configured to repeatedly transmit PRACHs to a network side device by using at least two beams on a resource in a target resource set corresponding to a first number when RSRP of at least one downlink reference signal measured by UE satisfies a target condition, where at least a part of beams of the at least two beams are different, the first number is a number of PRACH repetition transmission corresponding to the target condition, and the target condition is used to ensure that signal transmission quality of a beam or an antenna panel indicated by the network side device to the UE is greater than or equal to a signal transmission quality threshold.

According to a fourth aspect, a PRACH repetition transmission apparatus is provided, and the apparatus includes a receiving module. The receiving module is configured to receive, on a resource in a target resource set corresponding to a first number, PRACHs repeatedly transmitted by UE by using at least two beams, where at least a part of beams of the at least two beams are different, the first number is a number of PRACH repetition transmission corresponding to a target condition satisfied by RSRP of at least one downlink reference signal measured by the UE, and the target condition is used to ensure that signal transmission quality of a beam or an antenna panel indicated by a network side device to the UE is greater than or equal to a signal transmission quality threshold.

According to a fifth aspect, a terminal is provided. The terminal includes a processor and a memory. The memory stores a program or instructions capable of running on the processor, and the program or instructions are executed by the processor to implement the steps of the method according to the first aspect.

According to a sixth aspect, a terminal is provided, including a processor and a communication interface. The communication interface is configured to repeatedly transmit PRACHs to a network side device by using at least two beams on a resource in a target resource set corresponding to a first number when RSRP of at least one downlink reference signal measured by a terminal satisfies a target condition, where at least a part of beams of the at least two beams are different, the first number is a number of PRACH repetition transmission corresponding to the target condition, and the target condition is used to ensure that signal transmission quality of a beam or an antenna panel indicated by the network side device to the terminal is greater than or equal to a signal transmission quality threshold.

According to a seventh aspect, a network side device is provided. The network side device includes a processor and a memory. The memory stores a program or instructions capable of running on the processor, and the program or instructions are executed by the processor to implement the steps of the method according to the second aspect.

According to an eighth aspect, a network side device is provided, including a processor and a communication interface. The communication interface is configured to receive, on a resource in a target resource set corresponding to a first number, PRACHs repeatedly transmitted by UE by using at least two beams, where at least a part of beams of the at least two beams are different, the first number is a number of PRACH repetition transmission corresponding to a target condition satisfied by RSRP of at least one downlink reference signal measured by the UE, and the target condition is used to ensure that signal transmission quality of a beam or an antenna panel indicated by the network side device to the UE is greater than or equal to a signal transmission quality threshold.

According to a ninth aspect, a non-transitory readable storage medium is provided. The non-transitory readable storage medium stores a program or instructions, and the program or instructions are executed by a processor to implement the steps of the method according to the first aspect, or to implement the steps of the method according to the second aspect.

According to a tenth aspect, a wireless communication system is provided, including a terminal and a network side device. The terminal may be configured to perform the steps of the method according to the first aspect, and the network side device may be configured to perform the steps of the method according to the second aspect.

According to an eleventh aspect, a chip is provided. The chip includes a processor and a communication interface. The communication interface is coupled to the processor, and the processor is configured to run a program or instructions to implement the method according to the first aspect, or to implement the method according to the second aspect.

According to a twelfth aspect, a computer program/program product is provided. The computer program/program product is stored in a non-transitory storage medium, and the program/program product is executed by at least one processor to implement the steps of the PRACH repetition transmission method according to the first aspect, or to implement the steps of the PRACH repetition transmission method according to the second aspect.

### BRIEF DESCRIPTION OF THE DRAWINGS

FIG. 1 is a block diagram of a wireless communication system to which an embodiment of this application is applicable;

FIG. 2 is a schematic diagram of RO resource distribution at a moment in a related art;

FIG. 3 is a schematic diagram of a plurality of ROs associated with a same SSB and having different time domain positions in a related art;

FIG. 4 is a schematic diagram of a correspondence between an RSRP threshold and a number of PRACH repetitions in a related art;

FIG. 5 is a schematic diagram 1 of a relationship between accuracy of an optimal beam indication and an SNR in a related art;

FIG. 6 is a schematic diagram 2 of a relationship between accuracy of an optimal beam indication and an SNR in a related art;

FIG. 7 is a flowchart of a PRACH repetition transmission method according to an embodiment of this application;

FIG. 8 is a schematic diagram 1 of two RSRP thresholds corresponding to each number of PRACH repetition transmission according to an embodiment of this application;

FIG. 9 is a schematic diagram 2 of two RSRP thresholds corresponding to each number of PRACH repetition transmission according to an embodiment of this application;

FIG. 10 is a schematic diagram of an RSRP threshold corresponding to each number of PRACH repetition transmission configured by a network according to an embodiment of this application;

FIG. 11 is a flowchart of another PRACH repetition transmission method according to an embodiment of this application;

FIG. 12 is a schematic diagram of a structure of a PRACH repetition transmission apparatus according to an embodiment of this application;

FIG. 13 is a schematic diagram of a structure of another PRACH repetition transmission apparatus according to an embodiment of this application;

FIG. 14 is a schematic diagram of a communication device according to an embodiment of this application;

FIG. 15 is a schematic diagram of a hardware structure of a terminal according to an embodiment of this application; and

FIG. 16 is a schematic diagram of a hardware structure of a network side device according to an embodiment of this application.

### DESCRIPTION OF THE INVENTION

The following clearly describes technical solutions in embodiments of this application with reference to accompanying drawings in the embodiments of this application. Clearly, the described embodiments are merely some rather than all of the embodiments of this application. All other embodiments obtained by a person of ordinary skill in the art based on embodiments of this application shall fall within the protection scope of this application.

The terms “first”, “second”, and the like in this application are used to distinguish between similar objects instead of describing a specified order or sequence. It should be understood that terms used in this way are interchangeable under appropriate circumstances, so that the embodiments of this application can be implemented in a sequence other than that illustrated or described herein. Moreover, the terms “first” and “second” typically distinguish between objects of one category rather than limiting a quantity of objects. For example, there may be one or more first objects. In addition, “or” in this application represents at least one of connected objects. For example, “A or B” includes three solutions, that is, a solution 1: including A and not including B; a solution 2: including B and not including A; and a solution 3: including both A and B. The character “/” generally represents an “or” relationship between associated objects.

The term “indication” in this application may be either a direct indication (or an explicit indication) or an indirect indication (or an implicit indication). The direct indication may be understood as: A sender explicitly notifies, in a sent indication, a receiver of specific information, an operation that needs to be performed, a requested result, or other content. The indirect indication may be understood as: The receiver determines corresponding information based on the indication sent by the sender, or performs determining based on the indication sent by the sender, and determines, based on a determining result, the operation that needs to be performed, the requested result, or the like.

It should be noted that a technology described in the embodiments of this application is not limited to a long term evolution (LTE)/LTE-advanced (LTE-A) system, and may be further applied to other wireless communication systems, such as a code division multiple access (CDMA) system, a time division multiple access (TDMA) system, a frequency division multiple access (FDMA) system, an orthogonal frequency division multiple access (OFDMA) system, a single-carrier frequency-division multiple access (SC-FDMA) system, or another system. The terms “system” and “network” are often used interchangeably in the embodiments of this application. The technology described may be used for the systems and radio technologies described above, as well as other systems and radio technologies. The following describes a new radio (NR) system for illustrative purposes, and NR terms are used in most of the following descriptions. However, these technologies are also applicable to systems such as a 6^{th} generation (6G) communication system other than the NR system.

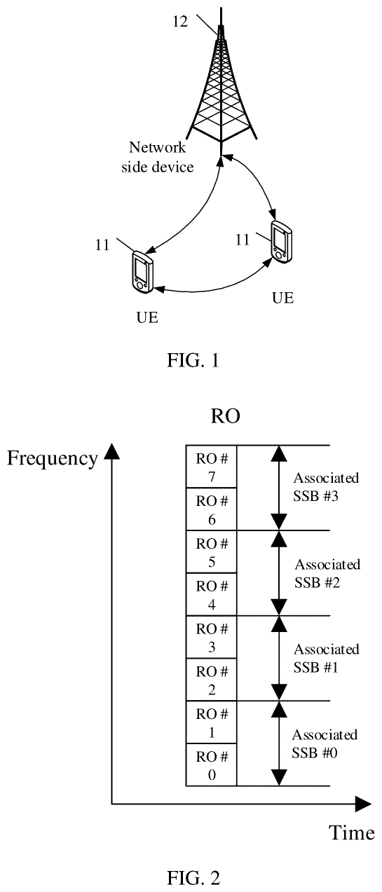

FIG. 1 is a block diagram of a wireless communication system to which an embodiment of this application is applicable. The wireless communication system includes UE 11 and a network side device 12. The UE 11 may be a mobile phone, a tablet personal computer, a laptop computer, a notebook computer, a personal digital assistant (PDA), a palmtop computer, a netbook, an ultra-mobile personal computer (UMPC), a mobile internet device (MID), an augmented reality (AR) device, a virtual reality (VR) device, a robot, a wearable device, a flight vehicle, vehicle user equipment (VUE), ship-mounted equipment, pedestrian user equipment (PUE), a smart home (a home device with a wireless communication function, for example, a refrigerator, a television, a laundry machine, or furniture), a game console, a personal computer (PC), a teller machine, a self-service machine, or another terminal side device. The wearable device includes a smartwatch, a smart band, a smart headset, smart glasses, smart jewelry (a smart bracelet, a smart wristlet, a smart ring, a smart necklace, a smart anklet, a smart leglet, and the like), a smart wristband, smart clothing, and the like. The vehicle user equipment may also be referred to as a vehicle-mounted terminal, a vehicle-mounted controller, a vehicle-mounted module, a vehicle-mounted component, a vehicle-mounted chip, a vehicle-mounted unit, or the like. It should be noted that a specific type of the UE 11 is not limited in the embodiments of this application. The network side device 12 may include an access network device or a core network device. The access network device may also be referred to as a radio access network (RAN) device, a radio access network function, or a radio access network unit. The access network device may include a base station, a wireless local area network (WLAN) access point (AS), a wireless fidelity (WiFi) node, and the like. The base station may be referred to as a NodeB (NB), an evolved NodeB (eNB), the next generation NodeB (gNB), a new radio NodeB (NR NodeB), an access point, a relay base station (RBS), a serving base station (SBS), a base transceiver station (BTS), a radio base station, a radio transceiver, a basic service set (BSS), an extended service set (ESS), a home NodeB (HNB), a home evolved NodeB, a transmission reception point (TRP), or another proper term in the field. The base station is not limited to a specific technical term, provided that a same technical effect is achieved. It should be noted that in the embodiments of this application, only a base station in an NR system is used as an example for description, and a specific type of the base station is not limited.

With reference to the accompanying drawings, a PRACH repetition transmission method and apparatus, a terminal, a network side device, and a non-transitory medium that are provided in the embodiments of this application are described below in detail by using some embodiments and application scenarios thereof.

Currently, random access procedures include a contention-based random access procedure and a contention-free random access procedure. The contention-based random access procedure includes contention-based 4-step random access.

In a contention-based 4-step random access process, UE first sends a Msg1 to a network, where the Msg1 includes a random access preamble (that is, a preamble). Then, after detecting the preamble, the network sends a Msg2/random access response (RAR) message to the UE, where the Msg2 is scheduled by using downlink control information (DCI) scrambled by a random access radio network temporary identifier (RA-RNTI). The RA-RNTI is related to a physical random access channel transmission occasion (PRACH Occasion, RO) resource used by the UE to send the Msg1, and is calculated in the following manner:

RA-RNTI=1+s_id+14×t_id+14×80×f_id+14×80×8×ul_carrier_id

s_id is an index of a first orthogonal frequency division multiplexing (OFDM) symbol of the PRACH occasion (0≤s_id<14). t_id is an index of a first slot of the PRACH occasion in a system frame (0≤t_id<80), and a subcarrier spacing for determining t_id is based on a value of specified in clause 5.3.2 in TS 38.211 [8]. For μ={0, 1, 2, 3} and μ={5, 6}, t_id is an index of a 120-kHz slot that includes the PRACH occasion in the system frame (0≤t_id<80). f_id is an index of the PRACH occasion in frequency domain (0≤f_id<8). ul_carrier_id represents an uplink (UL) carrier used for random access preamble transmission (0 represents a NUL carrier, and 1 represents a SUL carrier).

The foregoing message Msg2 includes a random access channel preamble identifier (RAPID), and an uplink radio resource allocated to the UE for transmitting a Msg3 physical uplink shared channel (PUSCH). The RAR grant field is shown in the following Table 1:

TABLE 1

| RAR grant field | Quantity of bits |
|---|---|
| Frequency hopping flag | 1 |
| PUSCH frequency domain | 14, used for running when there is |
| resource allocation | no shared spectrum channel access |
| | 12, used for running when there is |
| | shared spectrum channel access |
| PUSCH time domain resource | 4 |
| allocation | |
| Modulation and coding scheme | 4 |
| Transmit power control | 3 |
| command for a PUSCH | |
| channel state information | 1 |
| request | |
| Channel access-CPxet | 0, used for running when there is |
| | no shared spectrum channel access |
| | 2, used for running when there is |
| | shared spectrum channel access |

After the UE receives the foregoing Msg2, if it is determined that at least one of numbers of a preamble carried in the Msg2 is consistent with a number of the preamble transmitted by the UE, the UE sends, based on a resource indicated by the foregoing RAR message, a Msg3 that includes contention resolution information. If the network does not receive the Msg3, retransmission of the Msg3 PUSCH may be scheduled in a physical downlink control channel (PDCCH) scrambled by a temporary cell radio network temporary identifier (Temporary Cell RNTI, TC-RNTI). After receiving the Msg3, the network sends a Msg4 that includes contention resolution information. After receiving the Msg4, the UE determines that the included contention resolution information is consistent with that transmitted by the UE in the Msg3. In other words, 4-step random access is completed.

For the contention-based random access process, different UEs randomly select preambles for transmission. Thus, different UEs may select a same preamble on a same time-frequency radio resource for transmission. This case may be understood as a preamble conflict between the UEs. In this case, different UEs receive a same RAR. In this case, different UEs perform Msg3 PUSCH transmission based on scheduling information in the RAR UL grant. The network can obtain, on one Msg3 PUSCH scheduling resource, a PUSCH (including contention resolution information) transmitted by only one UE. Therefore, the network includes, in the Msg4, the contention resolution information received in the Msg3. If the contention resolution information in the Msg4 received by the UE matches the contention resolution information transmitted by the UE in the Msg3 PUSCH, the UE considers that contention resolution succeeds. If the contention resolution information does not match, the UE considers that contention resolution fails. In this case, the UE reselects a resource to perform a next random access attempt.

In NR, a cell may configure a plurality of frequency division multiplexing (FDM) ROs at one time domain position for transmitting a PRACH. At a moment, a quantity of FDM ROs may be {1, 2, 4, 8}, which may be determined through configuration by using a higher layer parameter msg1-FDM. For example, as shown in FIG. 2, at a moment, eight RO resources are distributed at different frequencies. A time domain position of an RO capable of transmitting a preamble is determined through configuration by using PRACHConfigurationIndex, a frequency domain resource is determined through configuration by using msg1-FDM, and the frequency domain resource n_RAE{0, 1, . . . , M−1}, where M is equal to the higher layer parameter msg1-FDM. A maximum preamble set on an RO is 64. For example, as shown in FIG. 2, RO resources are sequentially numbered RO #0 to RO #7 in ascending order of frequencies.

In NR, there is an association relationship between an RO and an actually sent synchronization signal block (SSB). One SSB may be associated with a plurality of ROs, or a plurality of SSBs may be associated with one RO (in this case, different SSBs correspond to different preamble subsets on the RO). Optionally, this may be configured by a network by using a parameter ssb-perRACH-OccasionAndCB-PreamblesPerSSB.

Generally, a base station may send different SSBs by using different beams. A quantity of SSBs is configured by using a parameter ssb-PositionsInBurst. For FR2, a maximum quantity of SSBs is 64. UE selects, based on strength of a received downlink beam/SSB, an RO associated with an SSB with a good signal, or a combination of an RO and a preamble, to send a Msg1. In this way, the network may determine, based on an RO of a received preamble or a combination of an RO and a preamble, the SSB selected by the UE, and send a Msg2 on a downlink beam corresponding to the SSB, to ensure received quality of a downlink signal.

For example, as shown in FIG. 2, there are eight FDM ROs and four SSBs at a moment, and each SSB is associated with two ROs. The UE may first select, based on RSRP of the received beam/SSB, an SSB whose RSRP is greater than a threshold. If there are a plurality of SSBs whose RSRP is greater than the threshold, the UE may select any SSB whose RSRP is greater than the threshold. When there is no SSB whose RSRP is greater than the threshold, the UE may select an SSB based on implementation. If the UE determines to transmit a PRACH/Msg1/preamble on an RO corresponding to an SSB #0, the UE may select one RO from the RO #0 and the RO #1 and select one preamble for transmission.

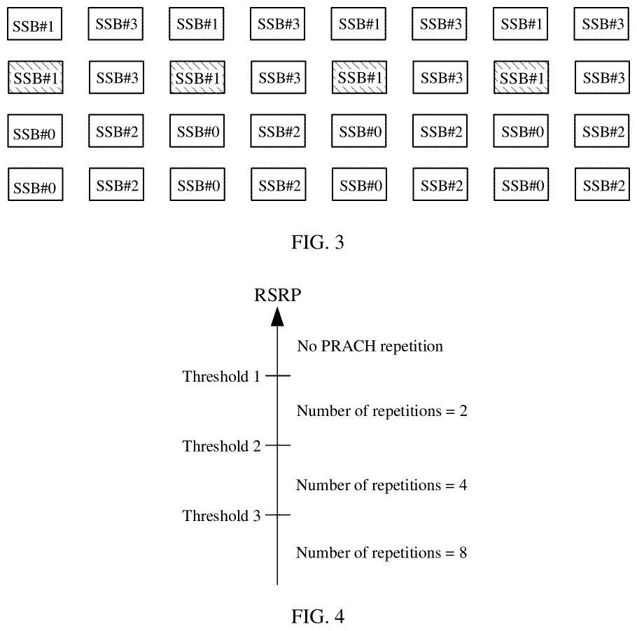

In a case of limited coverage, the UE needs to perform PRACH repetition to enhance uplink coverage performance. For PRACH repetition, the UE needs to repeatedly transmit the preamble on a plurality of ROs associated with a same SSB and having different time domain positions. A number of PRACH repetitions may be {2, 4, 8}. Different quantities of repetitions represent different features (that is, features), and PRACH resources corresponding to different features are configured independently. The UE may first determine the number of PRACH repetitions based on measured RSRP and an RSRP threshold configured by the network, and then select an RO set on a PRACH resource corresponding to the number of repetitions, where a quantity of valid ROs in the RO set is equal to the number of PRACH repetitions. For example, as shown in FIG. 3, assuming that the UE selects an SSB #1 and determines that the number of PRACH repetitions is 4, the UE needs to select, on a PRACH resource corresponding to such a feature, that is, the number 4 of PRACH repetitions, four ROs corresponding to the SSB #1 and having different time domain positions to form an RO set (that is, an RO group) for PRACH repetition transmission.

In current Rel-18, PRACH repetition transmission is same beam transmission associated with a same SSB. As shown in FIG. 3, the UE repeatedly transmits the PRACHs on the four ROs associated with the SSB #1, and the same beam is used for each time of transmission. A network side correspondingly configures an RSRP threshold for the configured number of PRACH repetitions. For the first RACH attempt, the UE determines a number of PRACH repetitions based on measured RSRP and an RSRP threshold configured by the network. For example, as shown in FIG. 4, the number of PRACH repetitions configured by the network is {2, 4, 8}, and corresponding RSRP thresholds are respectively {threshold 1, threshold 2, threshold 3}. If the threshold 3<the RSRP<the threshold 2, the UE may determine that the number of PRACH repetitions is 4; or if the RSRP measured by the UE<threshold 3, the UE may determine that the number of PRACH repetitions is 8.

Considering uplink coverage performance of the Msg3, PRACH repetition transmission of different beams may be introduced in future Rel-19 for beam alignment (that is, beam refinement). The UE may repeatedly transmit the PRACHs by using different beams. The network side determines an optimal beam or optimal PRACH transmission or an optimal PRACH transmission group by detecting each time of PRACH transmission, and then indicates, to the UE in the Msg2/RAR, the determined optimal beam or optimal PRACH transmission or optimal PRACH transmission group. Then, the UE may send the Msg3 by using the beam indicated by the network side or a beam used for the indicated PRACH. Alternatively, the UE has a plurality of antenna panels (that is, panels). The UE sequentially uses the panels to repeatedly transmit the PRACH. The network side determines a beam or a PRACH or a panel by detecting each time of PRACH transmission, and then indicates the beam or the PRACH or the panel to the UE. Then, the UE may select the panel indicated by the network or a panel corresponding to the indicated PRACH or beam as a panel for subsequent communication.

Therefore, whether the optimal beam or the optimal PRACH transmission or the optimal PRACH transmission group indicated by the network side in the Msg2/RAR is accurate directly affects the uplink coverage performance of the Msg3, and determines whether it is necessary to repeatedly transmit the PRACHs by using different beams. For indication of the beam/PRACH transmission/PRACH transmission group, some companies currently propose that the network side performs indication by using an RA-RNTI associated with a corresponding RO for transmitting the PRACH, that is, the network side schedules the Msg2 by using DCI scrambled by an RA-RNTI corresponding to an RO on which the selected PRACH is located.

PRACH repetitions of different beams are mainly used for beam refinement to enhance uplink coverage of the Msg3. Therefore, when determining whether to perform PRACH repetition of different beams and determining a number of repetitions, the UE needs to consider impact of Msg2/RAR beam indication accuracy.

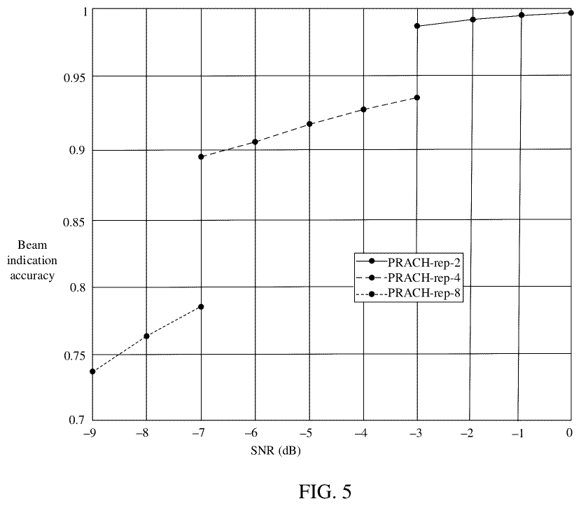

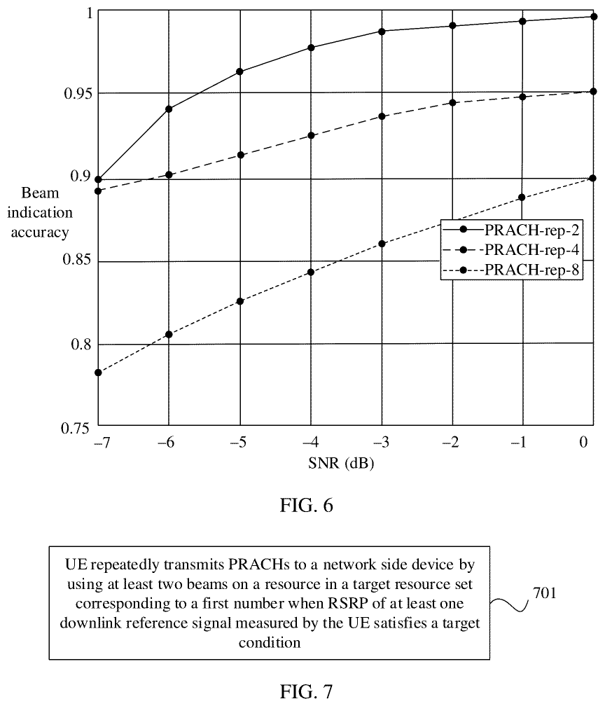

It is found through research that, for a same number of PRACH repetitions (that is, a same quantity of beams), accuracy of indicating an optimal beam/optimal PRACH by the network side to the UE increases with an increase in a signal-to-noise ratio (SNR) or RSRP. For different quantities of PRACH repetitions (that is, different quantities of beams), optimal beam/optimal PRACH indication accuracy therefor is different in an RSRP range in which a PRACH uplink coverage requirement is satisfied. For example, as shown in FIG. 5, optimal beam/optimal PRACH indication accuracy for quantities 2/4/8 of PRACH repetitions is different in an RSRP range in which respective coverage requirements are satisfied. In terms of same optimal beam indication accuracy, SNRs required for different quantities of PRACH repetitions are also different. For example, as shown in FIG. 6, when the optimal beam indication accuracy is 90%, SNRs required for quantities 2/4/8 of PRACH repetitions are −7/−6.3/0 dB respectively.

According to a method in current Rel-18, in a PRACH uplink coverage limited scenario, the UE determines, based on measured RSRP and an RSRP threshold corresponding to a configured number of PRACH repetitions, whether to perform PRACH repetition transmission and a number of PRACH repetitions. When an SNR is −9 dB, based on comparison with a threshold, the UE should select different beams whose quantities of PRACH repetitions are 8 for transmission. However, in this case, optimal beam indication accuracy is about 74%. If an optimal beam indication is inaccurate, PRACH repetitions of different beams are meaningless. In other words, the UE is allowed to perform PRACH repetition transmission of different beams in only an RSRP range in which optimal beam indication accuracy satisfies a requirement.

To resolve the foregoing problem, in a PRACH repetition transmission method provided in the embodiments of this application, UE may repeatedly transmit PRACHs to a network side device by using at least two beams on a resource in a target resource set corresponding to a first number when RSRP of at least one downlink reference signal measured by the UE satisfies a target condition, where at least a part of beams of the at least two beams are different, the first number is a number of PRACH repetition transmission corresponding to the target condition, and the target condition is used to ensure that signal transmission quality of a beam or an antenna panel indicated by the network side device to the UE is greater than or equal to a signal transmission quality threshold. In this solution, when the measured RSRP of the at least one reference signal satisfies the target condition, the UE may repeatedly transmit the PRACHs to the network side device on the resource corresponding to the number of PRACH repetition transmission corresponding to the target condition by using different beams, and the target condition may be used to ensure that the signal transmission quality of the beam or the antenna panel indicated by the network side device to the UE is greater than or equal to the signal transmission quality threshold. Therefore, after performing PRACH repetition transmission of different beams, the UE can receive a beam or an antenna panel that has optimal signal transmission quality and that is indicated by the network side device, thereby avoiding that the UE performs meaningless PRACH repetition transmission of different beams.

An embodiment of this application provides a PRACH repetition transmission method. FIG. 7 is a flowchart of a PRACH repetition transmission method according to an embodiment of this application. As shown in FIG. 7, the PRACH repetition transmission method provided in this embodiment of this application may include the following step 701.

It should be noted that a beam in this embodiment of this application may also be represented as one time of PRACH transmission in PRACH repetitions, and a beam group in this embodiment of this application may also be represented as a group of PRACH transmission in PRACH repetitions.

Step 701: UE repeatedly transmits PRACHs to a network side device by using at least two beams on a resource in a target resource set corresponding to a first number when RSRP of at least one downlink reference signal measured by the UE satisfies a target condition.

At least a part of beams of the at least two beams are different, the first number is a number of PRACH repetition transmission corresponding to the target condition, and the target condition is used to ensure that signal transmission quality of a beam or an antenna panel indicated by the network side device to the UE is greater than or equal to a signal transmission quality threshold.

Optionally, in this embodiment of this application, the signal transmission quality threshold may be preconfigured, predefined, or protocol-agreed.

Optionally, in this embodiment of this application, signal transmission quality greater than or equal to the signal transmission quality threshold may be optimal signal transmission quality.

Optionally, in this embodiment of this application, different quantities of PRACH repetition transmission times may correspond to different resource sets.

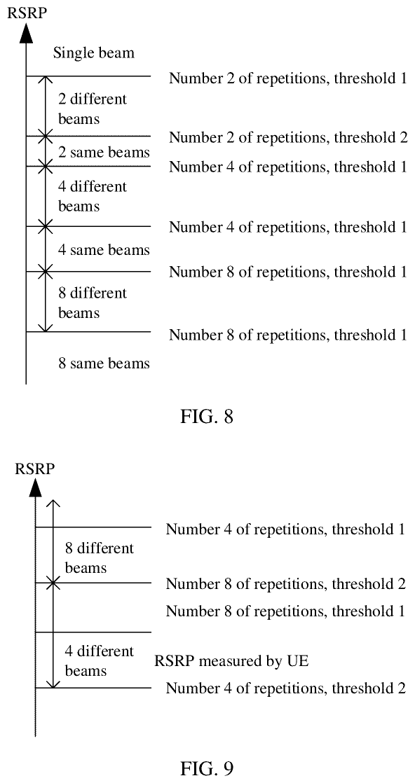

For example, as shown in FIG. 8, each number of PRACH repetition transmission corresponds to two RSRP thresholds (that is, a threshold 1 and a threshold 2). The threshold 1 is related to uplink coverage performance of different beams for repeatedly transmitting the PRACH, and the threshold 2 is related to beam/beam group indication accuracy and a number of PRACH repetitions. For each number of PRACH repetition transmission, there may be a different requirement on the beam/beam group indication accuracy, and the corresponding threshold 2 may be independently configured. It can be learned that, a threshold 2 for a number 2 of repetitions>a threshold 2 for a number 4 of repetitions>a threshold 2 for a number 8 of repetitions.

Optionally, in this embodiment of this application, that the RSRP of the at least one downlink reference signal satisfies the target condition may include at least one of the following 1.1 to 1.6:
1.1. RSRP of a downlink reference signal is greater than or equal to a first RSRP threshold;
1.2. first RSRP is greater than or equal to a second RSRP threshold, where the first RSRP is determined by the UE based on the RSRP of the at least one downlink reference signal;
1.3. a quantity of first downlink reference signals is greater than or equal to a first quantity threshold, where the first downlink reference signals are different downlink reference signals whose RSRP is greater than or equal to a third RSRP threshold in the at least one downlink reference signal;
1.4. a quantity of second downlink reference signals is less than or equal to a second quantity threshold, where the second downlink reference signals are different downlink reference signals whose RSRP is less than or equal to a fourth RSRP threshold in the at least one downlink reference signal;
1.5. a difference between RSRP of different downlink reference signals in the at least one downlink reference signal is less than or equal to a fifth RSRP threshold; or
1.6. RSRP of a target SSB is greater than or equal to a sixth RSRP threshold, where the target SSB is selected by the UE based on the RSRP of the at least one downlink reference signal.

Optionally, in this embodiment of this application, the foregoing downlink reference signal may be a reference signal used for path loss estimation.

Optionally, in this embodiment of this application, the first RSRP may be average RSRP measured based on the RSRP of the at least one downlink reference signal (for example, an SSB), or may be highest RSRP among the RSRP of the at least one downlink reference signal.

Optionally, in this embodiment of this application, different downlink reference signals in the at least one downlink reference signal may be different SSBs in at least one SSB. For example, the at least one downlink reference signal is M SSBs. Only when a largest RSRP difference between N (0≤N≤M) different SSBs does not exceed the fifth RSRP threshold that is configured or is determined according to a predefined rule, the UE is allowed to select a corresponding resource for PRACH repetition transmission of different beams.

Optionally, in this embodiment of this application, the first RSRP threshold or the second RSRP threshold may be a maximum threshold that corresponds to the first number and that is for selecting a resource for PRACH repetition transmission of a same beam, and may be a minimum threshold that corresponds to the first number and that is for selecting a resource for PRACH repetition transmission of different beams. That is, the maximum threshold that corresponds to the first number and that is for selecting a resource for PRACH repetition transmission of a same beam is the minimum threshold that corresponds to the first number and that is for selecting a resource for PRACH repetition transmission of different beams. In this way, a quantity of configured thresholds can be reduced.

For example, as shown in FIG. 8, each threshold 1 is used to determine a number of PRACH repetition transmission, and each threshold 2 is used to determine to repeatedly transmit the PRACHs by using different beams. For the number 2 of PRACH repetition transmission, a threshold 2 corresponding to the number 2 of PRACH repetition transmission is an upper limit of resource selection for two PRACH repetitions of a same beam, and is also a lower limit of resource selection for two PRACH repetitions of different beams. That is, when the RSRP measured by the UE satisfies: threshold 1 corresponding to the number 4 of PRACH repetition transmission<RSRP<threshold 2 corresponding to the number 2 of PRACH repetition transmission, the UE may select a resource corresponding to two PRACH repetitions of a same beam for transmission. In this case, an uplink coverage requirement of the PRACH can be satisfied. When the RSRP measured by the UE satisfies: threshold 2 corresponding to the number 2 of PRACH repetition transmission<RSRP<threshold 1 corresponding to the number 2 of PRACH repetition transmission, the UE may select a resource corresponding to two PRACH repetitions of different beams for transmission.

Optionally, in this embodiment of this application, the downlink reference signal in the at least one downlink reference signal may be an SSB.

Optionally, in this embodiment of this application, RSRP of each downlink reference signal in the first downlink reference signals is greater than or equal to the third RSRP threshold, and every two downlink reference signals in the first downlink reference signals are different.

Optionally, in this embodiment of this application, RSRP of each downlink reference signal in the second downlink reference signals is less than or equal to the fourth RSRP threshold, and every two downlink reference signals in the second downlink reference signals are different.

Optionally, in this embodiment of this application, the target SSB may be an SSB selected by the UE after the UE determines the number of PRACH repetition transmission based on the RSRP of the at least one downlink reference signal.

Optionally, in this embodiment of this application, the foregoing thresholds may be configured by the network side device, or may be determined according to a predefined rule.

Optionally, in this embodiment of this application, different quantities of PRACH repetition transmission times may correspond to different conditions used to ensure that the signal transmission quality is greater than or equal to the signal transmission quality threshold. Each threshold in the conditions corresponding to different quantities of PRACH repetition transmission times may be independently configured.

In this embodiment of this application, because that the RSRP of the at least one downlink reference signal satisfies the target condition may include at least one of the foregoing 1.1 to 1.6, when any condition in the foregoing 1.1 to 1.6 is satisfied, the UE may repeatedly transmit the PRACHs to the network side device on the resource in the target resource set by using the foregoing at least two beams, thereby improving flexibility of repeatedly transmitting the PRACHs by the UE by using different beams.

Optionally, in this embodiment of this application, the target resource set may include at least one RO group, and each RO group includes at least two ROs associated with a same SSB.

ROs located in different frames and having a same time-frequency position are not in a same RO group.

Optionally, in this embodiment of this application, the time-frequency position may be any one of the following: a slot, a symbol, or a frequency domain RO position.

For example, if an RO #1 is located in the 1^{st} system frame, an RO #2 is located in the 2^{nd} system frame, the RO #1 and RO #2 are located at the same slot and symbol positions in the 1^{st} system frame and the 2^{nd} system frame respectively, and frequency domain positions of the RO #1 and the RO #2 are the same, the RO #1 and the RO #2 cannot be determined into one RO group.

Optionally, in this embodiment of this application, when determining an RO group for PRACH repetition transmission of different beams, the UE may ensure, by using an RO frequency hopping method, that any two ROs in the RO group are not located at the same time-frequency position in different frames (there is a difference in at least one parameter in at least a time domain position t_id/s_id and a frequency domain position f_id, thereby ensuring that RA-RNTI calculation results are different).

Optionally, in this embodiment of this application, the network side device may indicate, by using DCI scrambled by an RA-RNTI corresponding to the m^{th} RO in the RO group, the UE to use a beam corresponding to the m^{th} RO.

In this embodiment of this application, because ROs located in different frames and having the same time-frequency position in the foregoing target resource set are not in the same RO group, it can be ensured that different ROs in an RO group/RO groups correspond to different RA-RNTIs, to facilitate subsequent beam indication.

Optionally, in this embodiment of this application, step 701 may be implemented by using the following step 701a.

Step 701a: The UE repeatedly transmits, on the resource in the target resource set by using the at least two beams whose quantity is the same as the first number, the PRACHs to the network side device for the first number when the RSRP of the at least one downlink reference signal satisfies the target condition.

For example, assuming that the first number is 8, the quantity of the at least two beams is also 8, and any two of the eight beams are different. The UE may use each of the eight beams for transmission once, to transmit the PRACH for eight times in total.

In this embodiment of this application, the UE may repeatedly transmit the PRACHs to the network side device for the first number on the resource in the target resource set by using the at least two beams whose quantity is the same as the first number corresponding to the satisfied target condition. Therefore, different uplink coverage requirements may be satisfied by using PRACH repetitions of different beams.

In the PRACH repetition transmission method provided in this embodiment of this application, when the measured RSRP of the at least one reference signal satisfies the target condition, the UE may repeatedly transmit the PRACHs to the network side device on the resource corresponding to the number of PRACH repetition transmission corresponding to the target condition by using different beams, and the target condition may be used to ensure that the signal transmission quality of the beam or the antenna panel indicated by the network side device to the UE is greater than or equal to the signal transmission quality threshold. Therefore, after performing PRACH repetition transmission of different beams, the UE can receive a beam or an antenna panel that has optimal signal transmission quality and that is indicated by the network side device, thereby avoiding that the UE performs meaningless PRACH repetition transmission of different beams.

Optionally, the PRACH repetition transmission method provided in this embodiment of this application may further include the following step 702.

Step 702: The UE repeatedly transmits, on the resource in the target resource set by using the at least two beams whose quantity is the same as a second number, the PRACHs to the network side device for the first number when the RSRP of the at least one downlink reference signal does not satisfy the target condition and is greater than or equal to at least one threshold corresponding to the second number.

The second number is a number of PRACH repetition transmission that is different from the first number.

In this embodiment of this application, the at least one threshold corresponding to the second number is a threshold corresponding to the second number in a condition used to ensure that the signal transmission quality is greater than or equal to the signal transmission quality threshold.

For example, as shown in FIG. 9, each threshold 1 is used to determine a number of PRACH repetition transmission, and each threshold 2 is used to determine to repeatedly transmit the PRACHs by using different beams. The UE determines, based on the measured RSRP and a threshold 1 corresponding to the number 8 of PRACH repetition transmission, that a number of PRACH repetitions is 8, that is, the PRACHs need to be repeatedly transmitted for eight times to satisfy a coverage requirement. However, the RSRP does not satisfy a requirement for a threshold 2 corresponding to the number 8 of PRACH repetition transmission (that is, does not satisfy a beam indication accuracy requirement), but satisfies a requirement for a threshold 2 corresponding to the number 4 of PRACH repetition transmission. In this case, the UE may select a resource set corresponding to the number 8 of PRACH repetition transmission of different beams, and use four different beams. Each beam is used for two times of repetition transmission, to transmit the PRACHs for eight times in total.

In this embodiment of this application, the UE may repeatedly transmit, on the resource in the target resource set by using the at least two beams whose quantity is the same as the second number that is different from the first number, the PRACHs to the network side device for the first number when the RSRP of the at least one downlink reference signal does not satisfy the target condition and is greater than or equal to the at least one threshold corresponding to the second number. Therefore, a condition for repeatedly transmitting the PRACHs by using different beams may be relaxed. When the target condition is not satisfied, different beams whose quantity is the same as the second number may still be used for transmission, so that different uplink coverage requirements can be satisfied as much as possible.

Optionally, in this embodiment of this application, before step 701, the PRACH repetition transmission method provided in this embodiment of this application may further include the following step 703 and step 704.

Step 703: The UE measures the RSRP of the at least one downlink reference signal, and determines second RSRP based on the RSRP of the at least one downlink reference signal.

Optionally, in this embodiment of this application, the second RSRP may be average RSRP measured based on the RSRP of the at least one downlink reference signal, or may be highest RSRP among the RSRP of the at least one downlink reference signal.

Step 704: When the second RSRP belongs to an RSRP range corresponding to the first number, and the UE supports repeatedly transmitting the PRACHs for the first number, the UE determines the first number as a number of repeatedly transmitting the PRACHs to the network side device by using the at least two beams.

Optionally, in this embodiment of this application, the network side device may preset an RSRP range corresponding to each number of PRACH repetition transmission.

For example, as shown in FIG. 8, each threshold 1 is used to determine a number of PRACH repetition transmission, and each threshold 2 is used to determine to repeatedly transmit the PRACHs by using different beams. If the second RSRP satisfies: threshold 1 for the number 4 of repetitions<second RSRP<threshold 1 for the number 2 of repetitions, that is, the second RSRP belongs to an RSRP range (threshold 1 for the number 4 of repetitions, threshold 1 for the number 2 of repetitions) corresponding to the number 2 of PRACH repetitions, the UE may determine that the number of PRACH repetitions is 2 (that is, an uplink coverage requirement for the PRACH can be satisfied by repeatedly transmitting the PRACHs twice by using different beams). If second RSRP>threshold 2 for the number 2 of repetitions, it indicates that beam indication accuracy can satisfy a requirement, and the UE may select a resource set corresponding to the number 2 of repetitions of different beams to repeatedly transmit the PRACHs by using different beams. Otherwise, the UE may select a resource set corresponding to the number 2 of repetitions of a same beam for transmission.

In this embodiment of this application, the UE may first determine the number of PRACH repetition transmission based on the measured RSRP of the at least one downlink reference signal, and then compare the RSRP of the at least one downlink reference signal with a condition corresponding to the number of PRACH repetition transmission. Therefore, a process of determining to repeatedly transmit the PRACHs by using different beams may be simplified.

Optionally, in this embodiment of this application, the UE may determine a number of PRACH repetitions of different beams based on a threshold that is configured by a network or determined according to a predefined rule and that is related to beam (group) indication accuracy, the measured RSRP, and a capability of the UE.

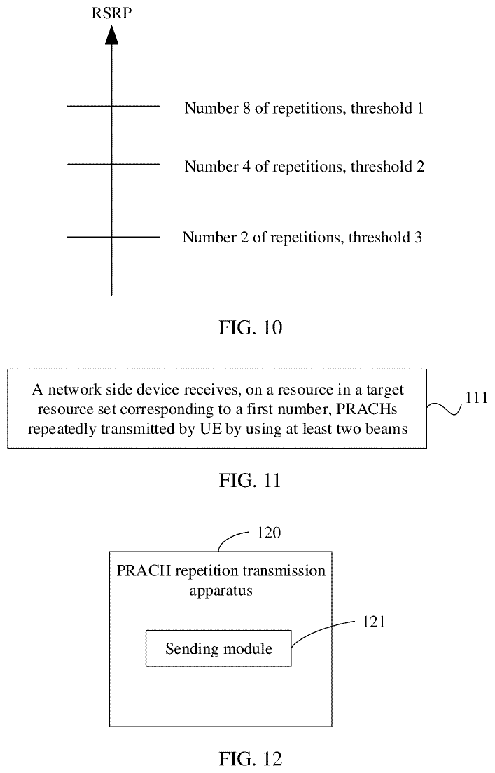

For example, as shown in FIG. 10, network-configured (for example, SIB1) or predefined quantities of repetitions are {N1, N2, N3}, and RSRP thresholds related to beam/beam group indication accuracy are {threshold 1, threshold 2, threshold 3}. If the RSRP measured by the UE satisfies: threshold 2<RSRP<threshold 1, and the UE supports transmission of 2/4/8 different beams, the UE may select a resource set corresponding to the number 4 of PRACH repetitions of different beams for transmission. If the RSRP measured by the UE satisfies: threshold 2<RSRP<threshold 1, but the capability of the UE supports transmission of only two different beams, the UE may not perform PRACH repetition transmission of different beams, or may perform transmission twice by using each of the two different beams based on implementation of the UE. If the RSRP measured by the UE satisfies: threshold 2<RSRP<threshold 1, but the capability of the UE supports transmission of only eight different beams, the UE may not perform PRACH repetition transmission of different beams, or may select four beams from the eight different beams to transmit the PRACHs based on implementation of the UE.

Optionally, in this embodiment of this application, in an initial access process, a number of PRACH repetition transmissions of different beams is a fixed value NO, and the value of NO may be predefined by a protocol (for example, is fixed as 2, 4, 8, or another integer greater than 1) or explicitly configured by using a system message, or reuse a number of repetitions of PRACH repetition transmission of a same beam in Rel-18 according to an implicit rule (for example, quantities of PRACH repetition transmission times configured for PRACH repetition transmission in Rel-18 are N1, N2, and N3, and a number of PRACH repetition transmissions of different beams in Rel-19 is the minimum value or the maximum value among {N1, N2, N3}).

Optionally, in this embodiment of this application, the UE determines a trigger threshold Thr0 for a PRACH repetition transmission procedure of different beams. The trigger threshold Thr0 may be explicitly configured by using a system message, or may reuse another threshold (for example, reuse a threshold corresponding to a number NO of PRACH repetition transmissions of a same beam in Rel-18, where NO corresponds to the minimum value or the maximum value among {N1, N2, N3}, and corresponds to NO determined by using the foregoing implicit rule; or reuse a threshold selected for an associated SSB in a 4-step random access procedure in Rel-15; or reuse a trigger threshold of a 2-step random access procedure in Rel-16, or other thresholds that may be configured in Rel-15, 16, 17, and 18).

Optionally, in this embodiment of this application, a trigger condition for triggering a PRACH repetition transmission procedure of different beams by the UE is as follows: When the RSRP of the downlink reference signal measured by the UE is greater than the trigger threshold Thr0, the UE uses NO different beams for PRACH repetition transmission. Otherwise, a same beam is used for PRACH repetition transmission, and a number of repetitions is determined according to a rule of a PRACH repetition transmission procedure of a same beam in Rel-18.

Optionally, in this embodiment of this application, after step 701, the PRACH repetition transmission method provided in this embodiment of this application may further include the following step 705 and step 706.

Step 705: The UE receives uplink transmission indication information sent by the network side device.

The uplink transmission indication information is used to indicate at least one of the following: a beam, a beam group, one time of PRACH transmission in PRACH repetition transmission, a group of PRACH transmission in PRACH repetition transmission, or an antenna panel.

Optionally, in this embodiment of this application, the beam/antenna panel may be a beam/an antenna panel selected by the network side device based on PRACH received quality. For example, the UE has two antenna panels in total, a number of PRACH repetitions is 4, and the two antenna panels sequentially transmit the PRACHs twice. Then, the network side indicates the UE to select the 2^{nd} antenna panel corresponding to the 3^{rd} time of PRACH transmission/the 3^{rd} beam. In this case, the UE may select the 2^{nd} antenna panel for subsequent uplink transmission.

Step 706: The UE determines, based on the uplink transmission indication information, an object indicated by the uplink transmission indication information as an object used for uplink transmission.

For example, if the uplink transmission indication information is used to indicate the foregoing beam, the UE may determine the beam as a beam used for uplink transmission. If the uplink transmission indication information is used to indicate the foregoing antenna panel, the UE may determine the antenna panel as an antenna panel used for uplink transmission.

In this embodiment of this application, the UE may determine, based on the received uplink transmission indication information, the object indicated by the uplink transmission indication information as the object used for uplink transmission, so that the UE can use an optimal beam or antenna panel indicated by the network side device to perform subsequent uplink transmission.

Optionally, in this embodiment of this application, the uplink transmission indication information may include at least one of the following 2.1 to 2.6:
2.1. an RAPID carried in a Msg2;
2.2. an RA-RNTI;
2.3. an RA-RNTI and target time unit information, where the target time unit information is related to PRACH transmission indicated by the uplink transmission indication information;
2.4. a reserved bit in DCI;
2.5. at least a part of bits of a field in an RAR; or
2.6. at least a part of bits of a plurality of fields in an RAR.

Optionally, in this embodiment of this application, the target time unit information may be carried in DCI.

Optionally, in this embodiment of this application, if the uplink transmission indication information includes the foregoing 2.1, the UE may perform PRACH repetition transmission by using different beams, and different PRACH transmission uses different preambles.

For example, the UE performs uplink PRACH repetition transmission by using eight different beams. Preambles used for the PRACH each time are sequentially {Preamble-1, Preamble-2, . . . , Preamble-8}. The UE detects a sequence number ID corresponding to Preamble-6 in an RAR message, and may send a subsequent Msg3 in uplink by using an uplink beam corresponding to Preamble-6.

For another example, the UE performs uplink PRACH repetition transmission for eight times by using four different beams. Preamble IDs used for every two times of PRACH repetition transmission are the same. That is, every two PRACH repetition transmissions are one group, and use a same beam. Preambles corresponding to eight times of different uplink transmission are respectively {Preamble-1, Preamble-1, Preamble-2, Preamble-2, Preamble-3, Preamble-3, Preamble-4, Preamble-4}. The UE detects an ID corresponding to Preamble-2 in an RAR message, and sends a subsequent Msg3 in uplink by using a transmit beam of a PRACH group (using a same beam) corresponding to Preamble-2.

For another example, the UE performs uplink PRACH repetition transmission by using eight different beams. Preamble IDs used for every two times of PRACH repetition transmission are the same. That is, every two beams are one beam group. Preambles corresponding to eight times of different uplink transmission are respectively {Preamble-1, Preamble-1, Preamble-2, Preamble-2, Preamble-3, Preamble-3, Preamble-4, Preamble-4}. The UE detects Preamble-2 in an RAR message, and selects (for example, based on implementation of the UE) one beam from a beam group (including two beams) corresponding to Preamble-2 to send a subsequent Msg3 in uplink.

For example, if the uplink transmission indication information includes the foregoing 2.5 or 2.6, the UE may use 1 bit of a CSI request to indicate one of two PRACHs/PRACH groups/PRACH beams/PRACH beam groups. For example, 1 or 2 bits of TPC may be used additionally to indicate one of four or eight PRACHs/PRACH groups/PRACH beams/PRACH beam groups in conjunction with 1 bit of the CSI request.

In this embodiment of this application, the uplink transmission indication information may include at least one of the foregoing 2.1 to 2.6. Therefore, the object used for uplink transmission may be indicated to the UE by using different uplink transmission indication information, thereby improving flexibility of indicating an uplink transmission resource to the UE.

Optionally, in this embodiment of this application, the target time unit information may be used to indicate at least one of the following 3.1 to 3.4:
3.1. a system frame number for one time of PRACH transmission;
3.2. a system frame number for a group of PRACH transmission;
3.3. a function value of a system frame number for one time of PRACH transmission; or
3.4. a function value of a system frame number for a group of PRACH transmission.

For example, the function value of the system frame number may be SFN mod (K/10), where K is a maximum window determined by an RO group, and is in a unit of ms.

In this embodiment of this application, the target time unit information may be used to indicate at least one of the foregoing 3.1 to 3.4, so that content of the uplink transmission indication information may be enriched, thereby improving flexibility of indicating an uplink transmission resource to the UE.

Optionally, in this embodiment of this application, the uplink transmission indication information includes the RA-RNTI.

The target resource set satisfies at least one of the following 4.1 and 4.2:
4.1. different ROs in any RO group in the target resource set correspond to different RA-RNTIs, and an RA-RNTI corresponding to an RO in the any RO group is different from an RA-RNTI corresponding to an RO that is not in an RO group in a same system frame; or
4.2. different ROs in any two RO groups in the target resource set correspond to different RA-RNTIs, and an RA-RNTI corresponding to an RO in any RO group in the target resource set is different from an RA-RNTI corresponding to an RO that is not in an RO group in a same system frame.

Optionally, in this embodiment of this application, a method for calculating RA-RNTIs corresponding to ROs in which different beams are located is as follows:

For all ROs in an RO group/RO groups, or for only ROs located at a same time-frequency position in different frames in an RO group/RO groups:

RA-RNTI=1+s_id+14×t_id+14×80×f_id+14×80×8×ul_carrier_id+Offset_m

A value of the offset Offset_m may ensure that RA-RNTIs of different ROs in an RO group/RO groups are different, and ensure a difference from an RA-RNTI of an RO that is not in an RO group in a same system frame. For descriptions of another parameter, refer to related descriptions in the foregoing related art. To avoid repetition, details are not described herein again.

Optionally, in this embodiment of this application, for RO groups, the network side device and the UE may ensure, according to a predefined rule, that RA-RNTIs corresponding to different ROs are different.

For example, for RO groups with overlapping RAR windows (for example, RAR windows corresponding to an RO group #1 and an RO group #2 overlap in time), the network side device and the UE ensure, according to a predefined rule such as the foregoing RA-RNTI calculation method, that RA-RNTIs corresponding to ROs in the two RO groups are different.

In this embodiment of this application, when the uplink transmission indication information includes the RA-RNTI, the target resource set needs to satisfy at least one of the foregoing 4.1 and 4.2. Therefore, it may be ensured that different ROs in an RO group/RO groups correspond to different RA-RNTIs, to facilitate subsequent beam indication.

Optionally, in this embodiment of this application, the uplink transmission indication information may be sent by the network side device by using higher layer signaling. For example, step 706 may be implemented by using the following step 706a.

Step 706a: The UE sends the uplink transmission indication information to a physical layer via a medium access control (MAC) layer, and determines, via the physical layer, the object indicated by the uplink transmission indication information as the object used for uplink transmission.

Optionally, in this embodiment of this application, the higher layer signaling may be an RAR, a MAC CE, or the like.

In this embodiment of this application, when the uplink transmission indication information is sent by using the higher layer signaling, the UE may indicate the uplink transmission indication information to the physical layer via the MAC layer, and determine, via the physical layer, the indicated object as the object used for uplink transmission. Therefore, resource information indicated by the network side device may be used for subsequent uplink transmission.

Optionally, in this embodiment of this application, if the uplink transmission indication information is used to indicate an antenna panel, the UE may use the indicated antenna panel as an antenna panel for subsequent communication.

Optionally, in this embodiment of this application, in a contention-free random access scenario, the network side device may indicate, by using RRC signaling or DCI, the UE to perform PRACH repetition transmission of different beams for beam alignment.

For example, during cell handover, the network side device may indicate, by using RRC signaling or DCI, that the UE may perform PRACH repetition transmission of different beams with quantities of PRACH repetitions being {N1, N2, . . . }, and configure a corresponding PRACH resource set. When the RSRP measured by the UE satisfies a corresponding threshold, the UE may select a resource from a corresponding resource set to perform PRACH repetition transmission of different beams.

For another example, the network side device may directly indicate, by using RRC signaling or DCI, the UE to perform PRACH repetition transmission of different beams with a number of repetitions being N, and the UE selects a resource from a corresponding resource set for transmission.

An embodiment of this application provides another PRACH repetition transmission method. FIG. 11 is a flowchart of a PRACH repetition transmission method according to an embodiment of this application. As shown in FIG. 11, the PRACH repetition transmission method provided in this embodiment of this application may include the following step 111.

Step 111: A network side device receives, on a resource in a target resource set corresponding to a first number, PRACHs repeatedly transmitted by UE by using at least two beams.

At least a part of beams of the at least two beams are different, the first number is a number of PRACH repetition transmission corresponding to a target condition satisfied by RSRP of at least one downlink reference signal measured by the UE, and the target condition is used to ensure that signal transmission quality of a beam or an antenna panel indicated by the network side device to the UE is greater than or equal to a signal transmission quality threshold.

Optionally, in this embodiment of this application, that the RSRP of the at least one downlink reference signal satisfies the target condition may include at least one of the following:
RSRP of a downlink reference signal is greater than or equal to a first RSRP threshold;
first RSRP is greater than or equal to a second RSRP threshold, where the first RSRP is determined by the UE based on the RSRP of the at least one downlink reference signal;
a quantity of first downlink reference signals is greater than or equal to a first quantity threshold, where the first downlink reference signals are different downlink reference signals whose RSRP is greater than or equal to a third RSRP threshold in the at least one downlink reference signal;
a quantity of second downlink reference signals is less than or equal to a second quantity threshold, where the second downlink reference signals are different downlink reference signals whose RSRP is less than or equal to a fourth RSRP threshold in the at least one downlink reference signal;
a difference between RSRP of different downlink reference signals in the at least one downlink reference signal is less than or equal to a fifth RSRP threshold; or
RSRP of a target SSB is greater than or equal to a sixth RSRP threshold, where the target SSB is selected by the UE based on the RSRP of the at least one downlink reference signal.

Optionally, in this embodiment of this application, the target resource set may include at least one RO group, and each RO group includes at least two ROs associated with a same SSB.

ROs located in different frames and having a same time-frequency position are not in a same RO group.

In the PRACH repetition transmission method provided in this embodiment of this application, the network side device may receive, on the resource corresponding to the number of PRACH repetition transmission corresponding to the target condition satisfied by the RSRP of the at least one downlink reference signal measured by the UE, the PRACHs repeatedly transmitted by the UE by using different beams, and the target condition may be used to ensure that the signal transmission quality of the beam or the antenna panel indicated by the network side device to the UE is greater than or equal to the signal transmission quality threshold. Therefore, a beam or an antenna panel that has optimal signal transmission quality may be indicated to the UE based on the PRACHs repeatedly transmitted by the UE by using different beams, thereby avoiding that the UE performs meaningless PRACH repetition transmission of different beams.

Optionally, in this embodiment of this application, after step 111, the PRACH repetition transmission method provided in this embodiment of this application may further include the following step 112.

Step 112: The network side device sends uplink transmission indication information to the UE.

The uplink transmission indication information is used to indicate at least one of the following: a beam, a beam group, one time of PRACH transmission in PRACH repetition transmission, a group of PRACH transmission in PRACH repetition transmission, or an antenna panel.

Optionally, in this embodiment of this application, the uplink transmission indication information may include at least one of the following:
an RAPID carried in a Msg2;
an RA-RNTI;
an RA-RNTI and target time unit information, where the target time unit information is related to PRACH transmission indicated by the uplink transmission indication information;
a reserved bit in DCI;
at least a part of bits of a field in an RAR; or
at least a part of bits of a plurality of fields in an RAR.

Optionally, in this embodiment of this application, the target time unit information may be used to indicate at least one of the following:
a system frame number for one time of PRACH transmission;
a system frame number for a group of PRACH transmission;
a function value of a system frame number for one time of PRACH transmission; or
a function value of a system frame number for a group of PRACH transmission.

Optionally, in this embodiment of this application, the uplink transmission indication information includes the RA-RNTI.

The target resource set satisfies at least one of the following:
different ROs in any RO group in the target resource set correspond to different RA-RNTIs, and an RA-RNTI corresponding to an RO in the any RO group is different from an RA-RNTI corresponding to an RO that is not in an RO group in a same system frame; or
different ROs in any two RO groups in the target resource set correspond to different RA-RNTIs, and an RA-RNTI corresponding to an RO in any RO group in the target resource set is different from an RA-RNTI corresponding to an RO that is not in an RO group in a same system frame.

For other descriptions in this embodiment of this application, refer to related descriptions in the foregoing UE side method embodiment. To avoid repetition, details are not described herein again.

The PRACH repetition transmission method provided in this embodiment of this application may be performed by a PRACH repetition transmission apparatus. In the embodiments of this application, an example in which the PRACH repetition transmission apparatus performs the PRACH repetition transmission method is used to describe the PRACH repetition transmission apparatus provided in the embodiments of this application.

With reference to FIG. 12, an embodiment of this application provides a PRACH repetition transmission apparatus 120. The PRACH repetition transmission apparatus 120 may include a sending module 121. The sending module 121 may be configured to repeatedly transmit PRACHs to a network side device by using at least two beams on a resource in a target resource set corresponding to a first number when RSRP of at least one downlink reference signal measured by UE satisfies a target condition, where at least a part of beams of the at least two beams are different, the first number is a number of PRACH repetition transmission corresponding to the target condition, and the target condition is used to ensure that signal transmission quality of a beam or an antenna panel indicated by the network side device to the UE is greater than or equal to a signal transmission quality threshold.

In a possible implementation, that the RSRP of the at least one downlink reference signal satisfies the target condition may include at least one of the following: RSRP of a downlink reference signal is greater than or equal to a first RSRP threshold; first RSRP is greater than or equal to a second RSRP threshold, where the first RSRP is determined by the UE based on the RSRP of the at least one downlink reference signal; a quantity of first downlink reference signals is greater than or equal to a first quantity threshold, where the first downlink reference signals are different downlink reference signals whose RSRP is greater than or equal to a third RSRP threshold in the at least one downlink reference signal; a quantity of second downlink reference signals is less than or equal to a second quantity threshold, where the second downlink reference signals are different downlink reference signals whose RSRP is less than or equal to a fourth RSRP threshold in the at least one downlink reference signal; a difference between RSRP of different downlink reference signals in the at least one downlink reference signal is less than or equal to a fifth RSRP threshold; or RSRP of a target SSB is greater than or equal to a sixth RSRP threshold, where the target SSB is selected by the UE based on the RSRP of the at least one downlink reference signal.

In a possible implementation, the target resource set may include at least one RO group, and each RO group includes at least two ROs associated with a same SSB; and ROs located in different frames and having a same time-frequency position are not in a same RO group.

In a possible implementation, the sending module 121 may be configured to repeatedly transmit, on the resource in the target resource set by using the at least two beams whose quantity is the same as the first number, the PRACHs to the network side device for the first number when the RSRP of the at least one downlink reference signal satisfies the target condition.

In a possible implementation, the sending module 121 may be further configured to repeatedly transmit, on the resource in the target resource set by using the at least two beams whose quantity is the same as a second number, the PRACHs to the network side device for the first number when the RSRP of the at least one downlink reference signal does not satisfy the target condition and is greater than or equal to at least one threshold corresponding to the second number, where the second number is a number of PRACH repetition transmission that is different from the first number.

In a possible implementation, the PRACH repetition transmission apparatus 120 may further include a first determining module. The first determining module may be configured to: before the sending module 121 repeatedly transmits the PRACHs to the network side device by using the at least two beams on the resource in the target resource set corresponding to the first number when the RSRP of the at least one downlink reference signal measured by the UE satisfies the target condition, measure the RSRP of the at least one downlink reference signal, and determine second RSRP based on the RSRP of the at least one downlink reference signal; and when the second RSRP belongs to an RSRP range corresponding to the first number, and the UE supports repeatedly transmitting the PRACHs for the first number, determine the first number as a number of repeatedly transmitting the PRACHs to the network side device by using the at least two beams.

In a possible implementation, the PRACH repetition transmission apparatus 120 may further include a receiving module and a second determining module. The receiving module may be configured to: after the sending module 121 repeatedly transmits the PRACHs to the network side device by using the at least two beams on the resource in the target resource set corresponding to the first number when the RSRP of the at least one downlink reference signal measured by the UE satisfies the target condition, receive uplink transmission indication information sent by the network side device, where the uplink transmission indication information is used to indicate at least one of the following: a beam, a beam group, one time of PRACH transmission in PRACH repetition transmission, a group of PRACH transmission in PRACH repetition transmission, or an antenna panel. The second determining module may be configured to determine, based on the uplink transmission indication information received by the receiving module, an object indicated by the uplink transmission indication information as an object used for uplink transmission.

In a possible implementation, the uplink transmission indication information may include at least one of the following: an RAPID carried in a Msg2; an RA-RNTI; an RA-RNTI and target time unit information, where the target time unit information is related to PRACH transmission indicated by the uplink transmission indication information; a reserved bit in DCI; at least a part of bits of a field in an RAR; or at least a part of bits of a plurality of fields in an RAR.

In a possible implementation, the uplink transmission indication information is sent by the network side device by using higher layer signaling. The second determining module may be configured to: send the uplink transmission indication information to a physical layer via a MAC layer, and determine, via the physical layer, the object indicated by the uplink transmission indication information as the object used for uplink transmission.

In the PRACH repetition transmission apparatus provided in this embodiment of this application, when the RSRP of the at least one reference signal measured by the UE satisfies the target condition, the PRACH repetition transmission apparatus may repeatedly transmit the PRACHs to the network side device on the resource corresponding to the number of PRACH repetition transmission corresponding to the target condition by using different beams, and the target condition may be used to ensure that the signal transmission quality of the beam or the antenna panel indicated by the network side device to the UE is greater than or equal to the signal transmission quality threshold. Therefore, after performing PRACH repetition transmission of different beams, the UE can receive a beam or an antenna panel that has optimal signal transmission quality and that is indicated by the network side device, thereby avoiding that the UE performs meaningless PRACH repetition transmission of different beams.

The PRACH repetition transmission apparatus in this embodiment of this application may be an electronic device, for example, an electronic device with an operating system; or may be a component, for example, an integrated circuit or a chip, in an electronic device. The electronic device may be UE. For example, the UE may include but is not limited to the foregoing enumerated types of the UE 11. This is not specifically limited in this embodiment of this application.

The PRACH repetition transmission apparatus provided in this embodiment of this application can implement the processes implemented in the foregoing UE side method embodiment, and a same technical effect can be achieved. To avoid repetition, details are not described herein again.

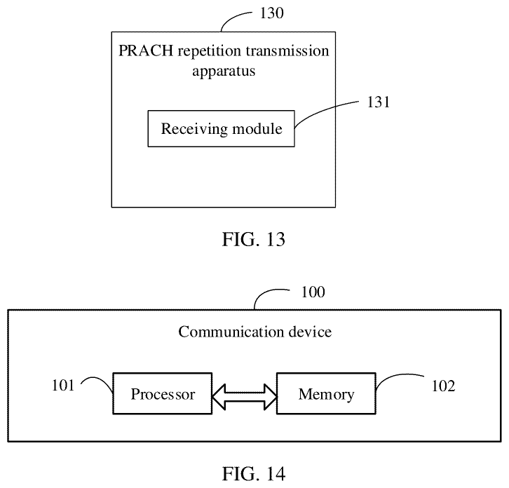

With reference to FIG. 13, an embodiment of this application provides another PRACH repetition transmission apparatus 130. The PRACH repetition transmission apparatus 130 may include a receiving module 131. The receiving module 131 may be configured to receive, on a resource in a target resource set corresponding to a first number, PRACHs repeatedly transmitted by UE by using at least two beams, where at least a part of beams of the at least two beams are different, the first number is a number of PRACH repetition transmission corresponding to a target condition satisfied by RSRP of at least one downlink reference signal measured by the UE, and the target condition is used to ensure that signal transmission quality of a beam or an antenna panel indicated by a network side device to the UE is greater than or equal to a signal transmission quality threshold.

In a possible implementation, that the RSRP of the at least one downlink reference signal satisfies the target condition may include at least one of the following: RSRP of a downlink reference signal is greater than or equal to a first RSRP threshold; first RSRP is greater than or equal to a second RSRP threshold, where the first RSRP is determined by the UE based on the RSRP of the at least one downlink reference signal; a quantity of first downlink reference signals is greater than or equal to a first quantity threshold, where the first downlink reference signals are different downlink reference signals whose RSRP is greater than or equal to a third RSRP threshold in the at least one downlink reference signal; a quantity of second downlink reference signals is less than or equal to a second quantity threshold, where the second downlink reference signals are different downlink reference signals whose RSRP is less than or equal to a fourth RSRP threshold in the at least one downlink reference signal; a difference between RSRP of different downlink reference signals in the at least one downlink reference signal is less than or equal to a fifth RSRP threshold; or RSRP of a target SSB is greater than or equal to a sixth RSRP threshold, where the target SSB is selected by the UE based on the RSRP of the at least one downlink reference signal.

In a possible implementation, the target resource set may include at least one RO group, and each RO group includes at least two ROs associated with a same SSB; and ROs located in different frames and having a same time-frequency position are not in a same RO group.

In a possible implementation, the PRACH repetition transmission apparatus 130 may further include a sending module. The sending module may be configured to send uplink transmission indication information to the UE after the receiving module 131 receives, on the resource in the target resource set corresponding to the first number, the PRACHs repeatedly transmitted by the UE by using the at least two beams, where the uplink transmission indication information is used to indicate at least one of the following: a beam, a beam group, one time of PRACH transmission in PRACH repetition transmission, a group of PRACH transmission in PRACH repetition transmission, or an antenna panel.

In a possible implementation, the uplink transmission indication information may include at least one of the following: an RAPID carried in a Msg2; an RA-RNTI; an RA-RNTI and target time unit information, where the target time unit information is related to PRACH transmission indicated by the uplink transmission indication information; a reserved bit in DCI; at least a part of bits of a field in an RAR; or at least a part of bits of a plurality of fields in an RAR.

In a possible implementation, the target time unit information may be used to indicate at least one of the following: a system frame number for one time of PRACH transmission; a system frame number for a group of PRACH transmission; a function value of a system frame number for one time of PRACH transmission; or a function value of a system frame number for a group of PRACH transmission.

In a possible implementation, the uplink transmission indication information includes the RA-RNTI. The target resource set satisfies at least one of the following: different ROs in any RO group in the target resource set correspond to different RA-RNTIs, and an RA-RNTI corresponding to an RO in the any RO group is different from an RA-RNTI corresponding to an RO that is not in an RO group in a same system frame; or different ROs in any two RO groups in the target resource set correspond to different RA-RNTIs, and an RA-RNTI corresponding to an RO in any RO group in the target resource set is different from an RA-RNTI corresponding to an RO that is not in an RO group in a same system frame.

In the PRACH repetition transmission apparatus provided in this embodiment of this application, the PRACH repetition transmission apparatus may receive, on the resource corresponding to the number of PRACH repetition transmission corresponding to the target condition satisfied by the RSRP of the at least one downlink reference signal measured by the UE, the PRACHs repeatedly transmitted by the UE by using different beams, and the target condition may be used to ensure that the signal transmission quality of the beam or the antenna panel indicated to the UE is greater than or equal to the signal transmission quality threshold. Therefore, a beam or an antenna panel that has optimal signal transmission quality may be indicated to the UE based on the PRACHs repeatedly transmitted by the UE by using different beams, thereby avoiding that the UE performs meaningless PRACH repetition transmission of different beams.

The PRACH repetition transmission apparatus in this embodiment of this application may be an electronic device, for example, an electronic device with an operating system; or may be a component, for example, an integrated circuit or a chip, in an electronic device. The electronic device may be another device other than UE. For example, the another device may be a server, a network attached storage (NAS), or the like. This is not specifically limited in this embodiment of this application.

The PRACH repetition transmission apparatus provided in this embodiment of this application can implement the processes implemented in the foregoing method embodiment of the network side device, and a same technical effect can be achieved. To avoid repetition, details are not described herein again.

As shown in FIG. 14, an embodiment of this application further provides a communication device 100, including a processor 101 and a memory 102. A program or instructions that can be run on the processor 101 are stored in the memory 102. For example, if the communication device 100 is UE, when the program or the instructions are executed by the processor 101, the steps of the foregoing UE side method embodiment are implemented, and a same technical effect can be achieved. If the communication device 100 is a network side device, when the program or the instructions are executed by the processor 101, the steps of the foregoing method embodiment of the network side device are implemented, and a same technical effect can be achieved. To avoid repetition, details are not described herein again.

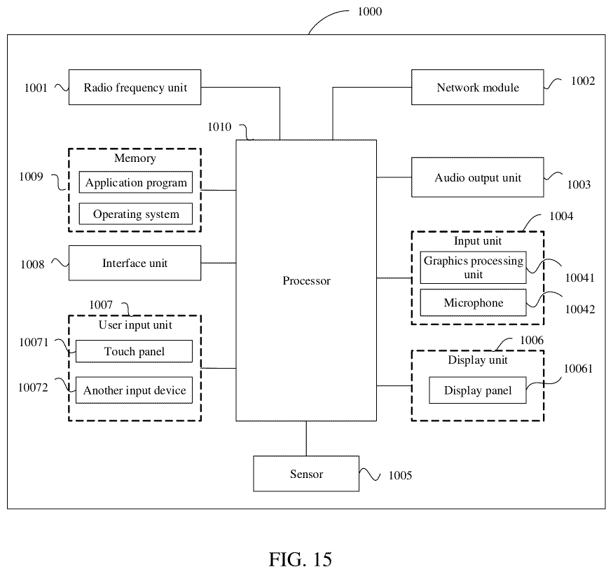

An embodiment of this application further provides a terminal, including a processor and a communication interface. The communication interface is coupled to the processor. The processor is configured to run a program or instructions to implement the steps in the foregoing UE side method embodiment. The communication interface is configured to repeatedly transmit PRACHs to a network side device by using at least two beams on a resource in a target resource set corresponding to a first number when RSRP of at least one downlink reference signal measured by the terminal satisfies a target condition, where at least a part of beams of the at least two beams are different, the first number is a number of PRACH repetition transmission corresponding to the target condition, and the target condition is used to ensure that signal transmission quality of a beam or an antenna panel indicated by the network side device to the terminal is greater than or equal to a signal transmission quality threshold. The terminal embodiment corresponds to the foregoing UE side method embodiment. Each implementation process and implementation of the foregoing method embodiment may be applied to the terminal embodiment, and the same technical effects can be achieved. Optionally, FIG. 15 is a schematic diagram of a hardware structure of a terminal for implementing an embodiment of this application.

The terminal 1000 includes but is not limited to at least some components of a radio frequency unit 1001, a network module 1002, an audio output unit 1003, an input unit 1004, a sensor 1005, a display unit 1006, a user input unit 1007, an interface unit 1008, a memory 1009, a processor 1010, and the like.

A person skilled in the art may understand that the terminal 1000 may further include a power supply (for example, a battery) that supplies power to each component. The power supply may be logically connected to the processor 1010 by using a power management system, to implement functions such as charging management, discharging management, and power consumption management through the power management system. The structure of the terminal shown in FIG. 15 does not constitute a limitation on the terminal. The terminal may include more or fewer components than those shown in the figure, or combine some components, or have different component arrangements. Details are not described herein again.

It should be understood that in this embodiment of this application, the input unit 1004 may include a graphics processing unit (GPU) 10041 and a microphone 10042, and the graphics processing unit 10041 processes image data of a still picture or a video obtained by an image capture apparatus (for example, a camera) in a video capture mode or an image capture mode. The display unit 1006 may include a display panel 10061, and the display panel 10061 may be configured in a form of a liquid crystal display, an organic light-emitting diode, or the like. The user input unit 1007 includes at least one of a touch panel 10071 and another input device 10072. The touch panel 10071 is also referred to as a touchscreen. The touch panel 10071 may include two parts: a touch detection apparatus and a touch controller. The another input device 10072 may include but is not limited to a physical keyboard, a function key (such as a volume control key or an on/offkey), a trackball, a mouse, and a joystick. Details are not described herein again.

In this embodiment of this application, after receiving downlink data from a network side device, the radio frequency unit 1001 can transmit the downlink data to the processor 1010 for processing. In addition, the radio frequency unit 1001 can send uplink data to the network side device. Generally, the radio frequency unit 1001 includes but is not limited to an antenna, an amplifier, a transceiver, a coupler, a low-noise amplifier, a duplexer, and the like.

The memory 1009 may be configured to store a software program or instructions and various types of data. The memory 1009 can mainly include a first storage area for storing a program or instructions and a second storage area for storing data. The first storage area can store an operating system, an application program or instructions required by at least one function (for example, a sound play function or an image play function), and the like. In addition, the memory 1009 may include a volatile memory or a nonvolatile memory. The non-volatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synch link dynamic random access memory (Synch link DRAM, SLDRAM), and a direct rambus random access memory (Direct Rambus RAM, DRRAM). The memory 1009 in this embodiment of this application includes but is not limited to these memories and any other suitable type of memory.

The processor 1010 may include one or more processing units. Optionally, the processor 1010 integrates an application processor and a modem processor. The application processor mainly processes operations related to an operating system, a user interface, an application program, and the like. The modem processor, for example, a baseband processor, mainly processes a wireless communication signal. It may be understood that, the foregoing modem processor may not be integrated into the processor 1010.

The radio frequency unit 1001 may be configured to repeatedly transmit PRACHs to a network side device by using at least two beams on a resource in a target resource set corresponding to a first number when RSRP of at least one downlink reference signal measured by the terminal 1000 satisfies a target condition, where at least a part of beams of the at least two beams are different, the first number is a number of PRACH repetition transmission corresponding to the target condition, and the target condition is used to ensure that signal transmission quality of a beam or an antenna panel indicated by the network side device to the terminal 1000 is greater than or equal to a signal transmission quality threshold.

In a possible implementation, that the RSRP of the at least one downlink reference signal satisfies the target condition may include at least one of the following: RSRP of a downlink reference signal is greater than or equal to a first RSRP threshold; first RSRP is greater than or equal to a second RSRP threshold, where the first RSRP is determined by the terminal 1000 based on the RSRP of the at least one downlink reference signal; a quantity of first downlink reference signals is greater than or equal to a first quantity threshold, where the first downlink reference signals are different downlink reference signals whose RSRP is greater than or equal to a third RSRP threshold in the at least one downlink reference signal; a quantity of second downlink reference signals is less than or equal to a second quantity threshold, where the second downlink reference signals are different downlink reference signals whose RSRP is less than or equal to a fourth RSRP threshold in the at least one downlink reference signal; a difference between RSRP of different downlink reference signals in the at least one downlink reference signal is less than or equal to a fifth RSRP threshold; or RSRP of a target SSB is greater than or equal to a sixth RSRP threshold, where the target SSB is selected by the terminal 1000 based on the RSRP of the at least one downlink reference signal.

In a possible implementation, the target resource set may include at least one RO group, and each RO group includes at least two ROs associated with a same SSB; and ROs located in different frames and having a same time-frequency position are not in a same RO group.

In a possible implementation, the radio frequency unit 1001 may be configured to repeatedly transmit, on the resource in the target resource set by using the at least two beams whose quantity is the same as the first number, the PRACHs to the network side device for the first number when the RSRP of the at least one downlink reference signal satisfies the target condition.

In a possible implementation, the radio frequency unit 1001 may be further configured to repeatedly transmit, on the resource in the target resource set by using the at least two beams whose quantity is the same as a second number, the PRACHs to the network side device for the first number when the RSRP of the at least one downlink reference signal does not satisfy the target condition and is greater than or equal to at least one threshold corresponding to the second number, where the second number is a number of PRACH repetition transmission that is different from the first number.

In a possible implementation, the processor 1010 may be configured to: before the radio frequency unit 1001 repeatedly transmits the PRACHs to the network side device by using the at least two beams on the resource in the target resource set corresponding to the first number when the RSRP of the at least one downlink reference signal measured by the terminal 1000 satisfies the target condition, measure the RSRP of the at least one downlink reference signal, and determine second RSRP based on the RSRP of the at least one downlink reference signal; and when the second RSRP belongs to an RSRP range corresponding to the first number, and the terminal 1000 supports repeatedly transmitting the PRACHs for the first number, determine the first number as a number of repeatedly transmitting the PRACHs to the network side device by using the at least two beams.

In a possible implementation, the radio frequency unit 1001 may be further configured to: after repeatedly transmitting the PRACHs to the network side device by using the at least two beams on the resource in the target resource set corresponding to the first number when the RSRP of the at least one downlink reference signal measured by the terminal 1000 satisfies the target condition, receive uplink transmission indication information sent by the network side device, where the uplink transmission indication information is used to indicate at least one of the following: a beam, a beam group, one time of PRACH transmission in PRACH repetition transmission, a group of PRACH transmission in PRACH repetition transmission, or an antenna panel. The processor 1010 may be further configured to determine, based on the uplink transmission indication information received by the radio frequency unit 1001, an object indicated by the uplink transmission indication information as an object used for uplink transmission.

In a possible implementation, the uplink transmission indication information may include at least one of the following: an RAPID carried in a Msg2; an RA-RNTI; an RA-RNTI and target time unit information, where the target time unit information is related to PRACH transmission indicated by the uplink transmission indication information; a reserved bit in DCI; at least a part of bits of a field in an RAR; or at least a part of bits of a plurality of fields in an RAR.

In a possible implementation, the uplink transmission indication information is sent by the network side device by using higher layer signaling. The processor 1010 may be configured to: send the uplink transmission indication information to a physical layer via a MAC layer, and determine, via the physical layer, the object indicated by the uplink transmission indication information as the object used for uplink transmission.

In the terminal provided in this embodiment of this application, when the RSRP of the at least one reference signal measured by the terminal satisfies the target condition, the terminal may repeatedly transmit the PRACHs to the network side device on the resource corresponding to the number of PRACH repetition transmission corresponding to the target condition by using different beams, and the target condition may be used to ensure that the signal transmission quality of the beam or the antenna panel indicated by the network side device to the terminal is greater than or equal to the signal transmission quality threshold. Therefore, after performing PRACH repetition transmission of different beams, the terminal can receive a beam or an antenna panel that has optimal signal transmission quality and that is indicated by the network side device, thereby avoiding that the terminal performs meaningless PRACH repetition transmission of different beams.

It may be understood that for implementation processes of the implementations mentioned in this embodiment, refer to related descriptions in the foregoing UE side method embodiment, and a same or corresponding technical effect is achieved. To avoid repetition, details are not described herein again.

An embodiment of this application further provides a network side device, including a processor and a communication interface. The communication interface is coupled to the processor. The processor is configured to run a program or instructions to implement the steps in the foregoing method embodiment of the network side device. The communication interface is configured to receive, on a resource in a target resource set corresponding to a first number, PRACHs repeatedly transmitted by UE by using at least two beams, where at least a part of beams of the at least two beams are different, the first number is a number of PRACH repetition transmission corresponding to a target condition satisfied by RSRP of at least one downlink reference signal measured by the UE, and the target condition is used to ensure that signal transmission quality of a beam or an antenna panel indicated by the network side device to the UE is greater than or equal to a signal transmission quality threshold. The network side device embodiment corresponds to the foregoing method embodiment of the network side device. Each implementation process and implementation of the foregoing method embodiment may be applied to the network side device embodiment, and a same technical effect can be achieved.

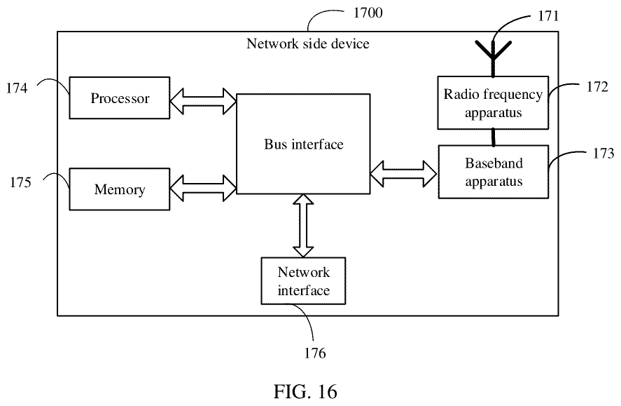

Optionally, an embodiment of this application further provides a network side device. As shown in FIG. 16, the network side device 1700 includes an antenna 171, a radio frequency apparatus 172, a baseband apparatus 173, a processor 174, and a memory 175. The antenna 171 is connected to the radio frequency apparatus 172. In an uplink direction, the radio frequency apparatus 172 receives information through the antenna 171, and sends the received information to the baseband apparatus 173 for processing. In a downlink direction, the baseband apparatus 173 processes to-be-sent information, and sends processed information to the radio frequency apparatus 172. After processing the received information, the radio frequency apparatus 172 sends processed information through the antenna 171.

A method performed by the network side device in the foregoing embodiments may be implemented in the baseband apparatus 173. The baseband apparatus 173 includes a baseband processor.

For example, the baseband apparatus 173 may include at least one baseband board. A plurality of chips are disposed on the baseband board. As shown in FIG. 16, one of the chips is, for example, the baseband processor, and is connected to the memory 175 by using a bus interface, to invoke a program in the memory 175 to perform an operation of a network device shown in the foregoing method embodiments.

The network side device may further include a network interface 176, and the interface is, for example, a common public radio interface (CPRI).

Optionally, the network side device 1700 in this embodiment of this application further includes instructions or a program stored in the memory 175 and capable of running on the processor 174. The processor 174 invokes the instructions or the program in the memory 175 to perform the method performed by the modules shown in FIG. 13, and achieve a same technical effect. To avoid repetition, details are not described herein again.

The radio frequency apparatus 172 may be configured to receive, on a resource in a target resource set corresponding to a first number, PRACHs repeatedly transmitted by UE by using at least two beams, where at least a part of beams of the at least two beams are different, the first number is a number of PRACH repetition transmission corresponding to a target condition satisfied by RSRP of at least one downlink reference signal measured by the UE, and the target condition is used to ensure that signal transmission quality of a beam or an antenna panel indicated by a network side device to the UE is greater than or equal to a signal transmission quality threshold.

In a possible implementation, that the RSRP of the at least one downlink reference signal satisfies the target condition may include at least one of the following: RSRP of a downlink reference signal is greater than or equal to a first RSRP threshold; first RSRP is greater than or equal to a second RSRP threshold, where the first RSRP is determined by the UE based on the RSRP of the at least one downlink reference signal; a quantity of first downlink reference signals is greater than or equal to a first quantity threshold, where the first downlink reference signals are different downlink reference signals whose RSRP is greater than or equal to a third RSRP threshold in the at least one downlink reference signal; a quantity of second downlink reference signals is less than or equal to a second quantity threshold, where the second downlink reference signals are different downlink reference signals whose RSRP is less than or equal to a fourth RSRP threshold in the at least one downlink reference signal; a difference between RSRP of different downlink reference signals in the at least one downlink reference signal is less than or equal to a fifth RSRP threshold; or RSRP of a target SSB is greater than or equal to a sixth RSRP threshold, where the target SSB is selected by the UE based on the RSRP of the at least one downlink reference signal.

In a possible implementation, the target resource set may include at least one RO group, and each RO group includes at least two ROs associated with a same SSB; and ROs located in different frames and having a same time-frequency position are not in a same RO group.

In a possible implementation, the radio frequency apparatus 172 may be further configured to send uplink transmission indication information to the UE after receiving, on the resource in the target resource set corresponding to the first number, the PRACHs repeatedly transmitted by the UE by using the at least two beams, where the uplink transmission indication information is used to indicate at least one of the following: a beam, a beam group, one time of PRACH transmission in PRACH repetition transmission, a group of PRACH transmission in PRACH repetition transmission, or an antenna panel.

In a possible implementation, the uplink transmission indication information may include at least one of the following: an RAPID carried in a Msg2; an RA-RNTI; an RA-RNTI and target time unit information, where the target time unit information is related to PRACH transmission indicated by the uplink transmission indication information; a reserved bit in DCI; at least a part of bits of a field in an RAR; or at least a part of bits of a plurality of fields in an RAR.

In a possible implementation, the target time unit information may be used to indicate at least one of the following: a system frame number for one time of PRACH transmission; a system frame number for a group of PRACH transmission; a function value of a system frame number for one time of PRACH transmission; or a function value of a system frame number for a group of PRACH transmission.

In a possible implementation, the uplink transmission indication information includes the RA-RNTI. The target resource set satisfies at least one of the following: different ROs in any RO group in the target resource set correspond to different RA-RNTIs, and an RA-RNTI corresponding to an RO in the any RO group is different from an RA-RNTI corresponding to an RO that is not in an RO group in a same system frame; or different ROs in any two RO groups in the target resource set correspond to different RA-RNTIs, and an RA-RNTI corresponding to an RO in any RO group in the target resource set is different from an RA-RNTI corresponding to an RO that is not in an RO group in a same system frame.

In the network side device provided in this embodiment of this application, the network side device may receive, on the resource corresponding to the number of PRACH repetition transmission corresponding to the target condition satisfied by the RSRP of the at least one downlink reference signal measured by the UE, the PRACHs repeatedly transmitted by the UE by using different beams, and the target condition may be used to ensure that the signal transmission quality of the beam or the antenna panel indicated by the network side device to the UE is greater than or equal to the signal transmission quality threshold. Therefore, a beam or an antenna panel that has optimal signal transmission quality may be indicated to the UE based on the PRACHs repeatedly transmitted by the UE by using different beams, thereby avoiding that the UE performs meaningless PRACH repetition transmission of different beams.

It may be understood that for implementation processes of the implementations mentioned in this embodiment, refer to related descriptions in the method embodiment of the network side device, and a same or corresponding technical effect is achieved. To avoid repetition, details are not described herein again.

An embodiment of this application further provides a non-transitory readable storage medium. The non-transitory readable storage medium stores a program or instructions. When the program or instructions are executed by a processor, each process of the foregoing PRACH repetition transmission method embodiment is implemented, with the same technical effect achieved. To avoid repetition, details are not described herein again.

The processor is a processor in the terminal described in the foregoing embodiments. The non-transitory readable storage medium includes a non-transitory computer-readable storage medium such as a computer read-only memory ROM, a random access memory RAM, a magnetic disk, or an optical disc.

In addition, an embodiment of this application provides a chip. The chip includes a processor and a communication interface. The communication interface is coupled to the processor. The processor is configured to run a program or instructions to implement each process of the foregoing PRACH repetition transmission method embodiment, with the same technical effect achieved. To avoid repetition, details are not described herein again.

It should be understood that the chip mentioned in this embodiment of this application may also be referred to as a system-level chip, a system chip, a chip system, a system on chip, or the like.

An embodiment of this application further provides a computer program/program product. The computer program/program product is stored in a non-transitory storage medium. The computer program/program product is executed by at least one processor to implement each process of the foregoing PRACH repetition transmission method embodiment, and the same technical effects can be achieved. To avoid repetition, details are not described herein again.

An embodiment of this application further provides a communication system, including a terminal and a network side device. The terminal may be configured to perform the steps of the foregoing UE side method, and the network side device may be configured to perform the steps of the foregoing method of the network side device.

It should be noted that in this specification, the term “include”, “comprise”, or any of their variants is intended to cover a non-exclusive inclusion, so that a process, method, article, or apparatus that includes a list of elements not only includes those elements but also includes other elements that are not expressly listed, or further includes elements inherent to such a process, method, article, or apparatus. Without more limitations, an element preceded by “includes a . . . ” does not preclude the existence of additional identical elements in the process, method, article, or apparatus that includes the element. In addition, it should be noted that the scope of the method and apparatus in the implementations of this application is not limited to performing functions in a sequence shown or discussed, and may further include performing functions in a basically simultaneous manner or in a reverse sequence based on related functions. For example, the described method may be performed in an order different from the described order, and various steps may be added, omitted, or combined. In addition, features described with reference to some examples may be combined in other examples.

According to the foregoing descriptions of the implementations, a person skilled in the art may clearly understand that the method in the foregoing embodiments may be implemented by a computer software product and a necessary general-purpose hardware platform, or certainly may be implemented by hardware. The computer software product is stored in a non-transitory storage medium (such as a ROM, a RAM, a magnetic disk, or an optical disc) and includes several instructions for enabling a terminal or a network side device to perform the methods described in the embodiments of this application.

The foregoing describes the embodiments of this application with reference to the accompanying drawings. However, this application is not limited to the foregoing implementations. The foregoing implementations are merely illustrative rather than restrictive. Inspired by this application, a person of ordinary skill in the art may develop many forms of implementations without departing from principles of this application and the protection scope of the claims, and all such implementations fall within the protection scope of this application.

What is claimed is:

1. A physical random access channel (PRACH) repetition transmission method, wherein the method comprises:
repeatedly transmitting, by user equipment (UE), PRACHs to a network side device by using at least two beams on a resource in a target resource set corresponding to a first number when reference signal received power (RSRP) of at least one downlink reference signal measured by the UE satisfies a target condition, wherein
at least a part of beams of the at least two beams are different, the first number is a number of PRACH repetition transmission corresponding to the target condition, and the target condition is used to ensure that signal transmission quality of a beam or an antenna panel indicated by the network side device to the UE is greater than or equal to a signal transmission quality threshold.

2. The method according to claim 1, wherein
that the RSRP of the at least one downlink reference signal satisfies the target condition comprises at least one of the following:
RSRP of a downlink reference signal is greater than or equal to a first RSRP threshold;
first RSRP is greater than or equal to a second RSRP threshold, wherein the first RSRP is determined by the UE based on the RSRP of the at least one downlink reference signal;
a quantity of first downlink reference signals is greater than or equal to a first quantity threshold, wherein the first downlink reference signals are different downlink reference signals whose RSRP is greater than or equal to a third RSRP threshold in the at least one downlink reference signal;
a quantity of second downlink reference signals is less than or equal to a second quantity threshold, wherein the second downlink reference signals are different downlink reference signals whose RSRP is less than or equal to a fourth RSRP threshold in the at least one downlink reference signal;
a difference between RSRP of different downlink reference signals in the at least one downlink reference signal is less than or equal to a fifth RSRP threshold; or
RSRP of a target synchronization signal block (SSB) is greater than or equal to a sixth RSRP threshold, wherein the target SSB is selected by the UE based on the RSRP of the at least one downlink reference signal.

3. The method according to claim 1, wherein the target resource set comprises at least one physical random access channel transmission occasion (RO) group, and each RO group comprises at least two ROs associated with a same SSB; and
ROs located in different frames and having a same time-frequency position are not in a same RO group.

4. The method according to claim 1, wherein the repeatedly transmitting, by UE, PRACHs to a network side device by using at least two beams on a resource in a target resource set corresponding to a first number when RSRP of at least one downlink reference signal measured by the UE satisfies a target condition comprises:
repeatedly transmitting, by the UE on the resource in the target resource set by using the at least two beams whose quantity is the same as the first number, the PRACHs to the network side device for the first number when the RSRP of the at least one downlink reference signal satisfies the target condition.

5. The method according to claim 1, wherein the method further comprises:
repeatedly transmitting, by the UE on the resource in the target resource set by using the at least two beams whose quantity is the same as a second number, the PRACHs to the network side device for the first number when the RSRP of the at least one downlink reference signal does not satisfy the target condition and is greater than or equal to at least one threshold corresponding to the second number, wherein
the second number is a number of PRACH repetition transmission that is different from the first number.

6. The method according to claim 1, wherein before the repeatedly transmitting, by UE, PRACHs to a network side device by using at least two beams on a resource in a target resource set corresponding to a first number when RSRP of at least one downlink reference signal measured by the UE satisfies a target condition, the method further comprises:
measuring, by the UE, the RSRP of the at least one downlink reference signal, and determining second RSRP based on the RSRP of the at least one downlink reference signal; and
when the second RSRP belongs to an RSRP range corresponding to the first number, and the UE supports repeatedly transmitting the PRACHs for the first number, determining, by the UE, the first number as a number of repeatedly transmitting the PRACHs to the network side device by using the at least two beams.

7. The method according to claim 1, wherein after the repeatedly transmitting, by UE, PRACHs to a network side device by using at least two beams on a resource in a target resource set corresponding to a first number when RSRP of at least one downlink reference signal measured by the UE satisfies a target condition, the method further comprises:
receiving, by the UE, uplink transmission indication information sent by the network side device, wherein the uplink transmission indication information is used to indicate at least one of the following: a beam, a beam group, one time of PRACH transmission in PRACH repetition transmission, a group of PRACH transmission in PRACH repetition transmission, or an antenna panel; and
determining, by the UE based on the uplink transmission indication information, an object indicated by the uplink transmission indication information as an object used for uplink transmission.

8. The method according to claim 7, wherein
the uplink transmission indication information comprises at least one of the following:
a random access channel preamble identifier (RAPID) carried in a message Msg2;
a random access radio network temporary identifier (RA-RNTI);
an RA-RNTI and target time unit information, wherein the target time unit information is related to PRACH transmission indicated by the uplink transmission indication information;
a reserved bit in downlink control information (DCI);
at least a part of bits of a field in a random access response (RAR); or
at least a part of bits of a plurality of fields in an RAR.

9. The method according to claim 7, wherein the uplink transmission indication information is sent by the network side device by using higher layer signaling; and
the determining, by the UE based on the uplink transmission indication information, an object indicated by the uplink transmission indication information as an object used for uplink transmission comprises:
transmitting, by the UE, the uplink transmission indication information to a physical layer via a medium access control (MAC) layer, and determining, via the physical layer, the object indicated by the uplink transmission indication information as the object used for uplink transmission.

10. A PRACH repetition transmission method, wherein the method comprises:
receiving, by a network side device on a resource in a target resource set corresponding to a first number, PRACHs repeatedly transmitted by UE by using at least two beams, wherein
at least a part of beams of the at least two beams are different, the first number is a number of PRACH repetition transmission corresponding to a target condition satisfied by RSRP of at least one downlink reference signal measured by the UE, and the target condition is used to ensure that signal transmission quality of a beam or an antenna panel indicated by the network side device to the UE is greater than or equal to a signal transmission quality threshold.

11. The method according to claim 10, wherein
that the RSRP of the at least one downlink reference signal satisfies the target condition comprises at least one of the following:
RSRP of a downlink reference signal is greater than or equal to a first RSRP threshold;
first RSRP is greater than or equal to a second RSRP threshold, wherein the first RSRP is determined by the UE based on the RSRP of the at least one downlink reference signal;
a quantity of first downlink reference signals is greater than or equal to a first quantity threshold, wherein the first downlink reference signals are different downlink reference signals whose RSRP is greater than or equal to a third RSRP threshold in the at least one downlink reference signal;
a quantity of second downlink reference signals is less than or equal to a second quantity threshold, wherein the second downlink reference signals are different downlink reference signals whose RSRP is less than or equal to a fourth RSRP threshold in the at least one downlink reference signal;
a difference between RSRP of different downlink reference signals in the at least one downlink reference signal is less than or equal to a fifth RSRP threshold; or
RSRP of a target SSB is greater than or equal to a sixth RSRP threshold, wherein the target SSB is selected by the UE based on the RSRP of the at least one downlink reference signal.

12. The method according to claim 10, wherein the target resource set comprises at least one RO group, and each RO group comprises at least two ROs associated with a same SSB; and
ROs located in different frames and having a same time-frequency position are not in a same RO group.

13. The method according to claim 10, wherein after the receiving, by a network side device on a resource in a target resource set corresponding to a first number, PRACHs repeatedly transmitted by UE by using at least two beams, the method further comprises:
transmitting, by the network side device, uplink transmission indication information to the UE, wherein
the uplink transmission indication information is used to indicate at least one of the following: a beam, a beam group, one time of PRACH transmission in PRACH repetition transmission, a group of PRACH transmission in PRACH repetition transmission, or an antenna panel.

14. The method according to claim 13, wherein
the uplink transmission indication information comprises at least one of the following:
an RAPID carried in a Msg2;
an RA-RNTI;
an RA-RNTI and target time unit information, wherein the target time unit information is related to PRACH transmission indicated by the uplink transmission indication information;
a reserved bit in DCI;
at least a part of bits of a field in an RAR; or
at least a part of bits of a plurality of fields in an RAR.

15. The method according to claim 14, wherein
the target time unit information is used to indicate at least one of the following:
a system frame number for one time of PRACH transmission;
a system frame number for a group of PRACH transmission;
a function value of a system frame number for one time of PRACH transmission; or
a function value of a system frame number for a group of PRACH transmission.

16. The method according to claim 14, wherein the uplink transmission indication information comprises the RA-RNTI; and
the target resource set satisfies at least one of the following:
different ROs in any RO group in the target resource set correspond to different RA-RNTIs, and an RA-RNTI corresponding to an RO in the any RO group is different from an RA-RNTI corresponding to an RO that is not in an RO group in a same system frame; or
different ROs in any two RO groups in the target resource set correspond to different RA-RNTIs, and an RA-RNTI corresponding to an RO in any RO group in the target resource set is different from an RA-RNTI corresponding to an RO that is not in an RO group in a same system frame.

17. A terminal, comprising a processor and a memory, wherein the memory stores a program or instructions capable of running on the processor, and the program or instructions, when executed by the processor, cause the terminal to perform:
repeatedly transmitting physical random access channels (PRACHs) to a network side device by using at least two beams on a resource in a target resource set corresponding to a first number, when reference signal received power (RSRP) of at least one downlink reference signal measured by the terminal satisfies a target condition, wherein
at least a part of beams of the at least two beams are different, the first number is a number of PRACH repetition transmission corresponding to the target condition, and the target condition is used to ensure that signal transmission quality of a beam or an antenna panel indicated by the network side device to the terminal is greater than or equal to a signal transmission quality threshold.

18. The terminal according to claim 17, wherein the program or instructions, when executed by the processor, cause the terminal to further perform:
receiving uplink transmission indication information sent by the network side device, wherein the uplink transmission indication information is used to indicate at least one of the following: a beam, a beam group, one time of PRACH transmission in PRACH repetition transmission, a group of PRACH transmission in PRACH repetition transmission, or an antenna panel; and
determining, based on the uplink transmission indication information, an object indicated by the uplink transmission indication information as an object used for uplink transmission.

19. The terminal according to claim 18, wherein the uplink transmission indication information comprises at least one of the following:
a random access channel preamble identifier (RAPID) carried in a message Msg2;
a random access radio network temporary identifier (RA-RNTI);
an RA-RNTI and target time unit information, wherein the target time unit information is related to PRACH transmission indicated by the uplink transmission indication information;
a reserved bit in downlink control information (DCI);
at least a part of bits of a field in a random access response (RAR); or
at least a part of bits of a plurality of fields in an RAR.

20. A network side device, comprising a processor and a memory, wherein the memory stores a program or instructions capable of running on the processor, and the program or instructions are executed by the processor to implement the steps of the PRACH repetition transmission method according to claim 10.
